(19) United States
(12) Patent Application Publication
(10) Pub. No.: US 2015/0147742 A1
(43) Pub. Date: May 28, 2015

(54) SYSTEM AND METHOD FOR ASSEMBLING EDUCATIONAL MATERIALS

(71) Applicant: MACAT INTERNATIONAL LIMITED, London (GB)

(72) Inventor: Salah Eldin Adel Youssef Khalil, London (GB)

(73) Assignee: Macat International Limited, London (GB)

(21) Appl. No.: 14/406,022

(22) PCT Filed: May 31, 2013
(86) PCT No.: PCT/GB2013/051454

§ 371 Date: Dec. 5, 2014

(30) Foreign Application Priority Data
Jun. 8, 2012 (GB) 1210167.1

(51) Int. Cl. G09B 5/00; G06F 3/0484; G06F 3/0482

(52) U.S. Cl. CPC G09B 5/00; G06F 3/0482; G06F 3/04842
USPC 434/362; 715/781

(57) ABSTRACT

An electronic system and method for providing educational course materials including rendering a graphical user interface comprising a plurality of separately rendered connected screens on the display device. The rendered screens of the graphical user interface include active areas selectable using the user input means to navigate between connected ones of the rendered screens. The rendered screens are connected in a structure corresponding to the data structure of the plurality of data items. The rendered screens of the graphical user interface include active areas selectable using the user input means to enable user selection of data items from the plurality of data items. The method further includes using the user input means to select active areas of the rendered screens of the graphical user interface to navigate between connected ones of the rendered screens; using the user input means to select active areas of the rendered screens of the graphical user interface to select data items from the plurality of data items; and grouping the selected data items to form educational course materials.

### FIELD OF THE INVENTION

This invention relates to a system and method for assembling educational materials, and in particular to a system and method for assembling educational course materials to support a study course.

### DESCRIPTION OF THE RELATED ART

Educational materials to support a study courses are traditionally assembled manually by academic or teaching staff based on their own knowledge of their specialist fields.

There are a number of problems with such traditional methods. The need for the academic or teaching specialist staff to assemble the course materials makes the cost of assembling materials for a new course, or updating or amending the materials used for a course, relatively high, both in financial terms and in terms of the opportunity cost of the staff being unavailable for other tasks. As a result the range of courses made available or supported by academic or teaching institutions is more limited than would be desired by many students, and there is a tendency for course materials to fail to fully reflect current thinking due to unduly long periods between updating.

### SUMMARY OF THE INVENTION

According to a first aspect the invention provides an electronic system for providing educational course materials, the system comprising: a processor connected to a data store, a display device, and a user input means; the data store containing a plurality of data items arranged in a data structure; the processor being configured to render a graphical user interface comprising a plurality of separately renderable connected screens on the display device, wherein: the renderable screens of the graphical user interface comprise active areas selectable using the user input means to navigate between connected ones of the renderable screens; the renderable screens being connected in a structure corresponding to the data structure of the plurality of data items; the renderable screens of the graphical user interface comprise active areas selectable using the user input means to enable user selection of data items from the plurality of data items; and the processor being configured to group the selected data items to form educational course materials.

Preferably, the data structure of the plurality of data items is a hierarchical data structure, and the renderable screens are connected in a hierarchical structure corresponding to the hierarchical data structure.

Preferably, the data structure comprises a plurality of topics, and a plurality of data items relating to each topic.

Preferably, the data items relating to each topic are grouped into a plurality of analyses, the analyses are grouped into a plurality of modules, and the modules are grouped into a plurality of sets, whereby each topic has an associated plurality of sets of modules of analyses of data items.

Preferably, each topic has the same number of sets associated with it, each set comprises the same number of modules, each module comprises the same number of analyses, and each analysis comprises the same number of data items.

Preferably, the analyses relating to different topics are derived from the corresponding topics according to a consistent common arrangement.

Preferably, each topic has three sets associated with it, each set comprises three modules, each module comprises three analyses, and each analysis comprises four data items.

Preferably, the data items within each set relate to a different facet of the topic.

Preferably, each topic has first, second and third sets associated with it, and the data items in a first set relate to facts regarding the topic, the data items in the second set relate to interpretation and explanation of the facts, and the data items in the third set relate to critical responses to the facts.

Preferably, the data structure comprises a plurality of subjects, and each subject comprises a plurality of topics.

Preferably, a topic corresponds to a book.

Preferably, the renderable screens comprise a plurality of renderable screens which each correspond to a specific data item.

Preferably, the data store further contains links between different data items in the data structure; and the renderable screen corresponding to a specific data item comprises an area identifying different data items in the data structure which are linked to the specific data item.

Preferably, the area identifying different data items in the data structure comprises an active area selectable using the user input means to navigate to a renderable screen corresponding to a different data item in the data structure which is linked to the specific data item.

Preferably, the area identifying different data items in the data structure can display a plurality of different data items.

Preferably, the area identifying different data items in the data structure can display a sorted list of different data items.

Preferably, the data store further contains weighting values associated with the links between different data items in the data structure; and the sorted list of data items is sorted in order based, at least in part, on the weighting values associated with the links.

Preferably, the display device is a touch screen device.

Preferably, the touch screen device also acts as the user input means.

According to a second aspect the invention provides a method for providing educational course materials using an electronic system comprising a processor connected to a data store containing a plurality of data items arranged in a data structure, a display device, and a user input means, the method comprising: rendering a graphical user interface comprising a plurality of separately rendered connected screens on the display device, wherein: the rendered screens of the graphical user interface comprise active areas selectable using the user input means to navigate between connected ones of the rendered screens; the rendered screens are connected in a structure corresponding to the data structure of the plurality of data items; and the rendered screens of the graphical user interface comprise active areas selectable using the user input means to enable user selection of data items from the plurality of data items; the method further comprising: using the user input means to select active areas of the rendered screens of the graphical user interface to navigate between connected ones of the rendered screens; using the user input means to select active areas of the rendered screens of the graphical user interface to select data items from the plurality of data items; and grouping the selected data items to form educational course materials.

Preferably, the data structure of the plurality of data items is a hierarchical data structure, and the rendered screens are connected in a hierarchical structure corresponding to the hierarchical data structure.

Preferably, the data structure comprises a plurality of topics, and a plurality of data items relating to each topic.

Preferably, the data items relating to each topic are grouped into a plurality of analyses, the analyses are grouped into a plurality of modules, and the modules are grouped into a plurality of sets, whereby each topic has an associated plurality of sets of modules of analyses of data items.

Preferably, each topic has the same number of sets associated with it, each set comprises the same number of modules, each module comprises the same number of analyses, and each analysis comprises the same number of data items.

Preferably, the analyses relating to different topics are derived from the corresponding topics according to a consistent common arrangement.

Preferably, each topic has three sets associated with it, each set comprises three modules, each module comprises three analyses, and each analysis comprises four data items.

Preferably, the data items within each set relate to a different facet of the topic.

Preferably, each topic has first, second and third sets associated with it, and the data items in a first set relate to facts regarding the topic, the data items in the second set relate to interpretation and explanation of the facts, and the data items in the third set relate to critical responses to the facts.

Preferably, the data structure comprises a plurality of subjects, and each subject comprises a plurality of topics.

Preferably, a topic corresponds to a book.

Preferably, the rendered screens comprise a plurality of renderable screens which each correspond to a specific data item.

Preferably, the data store further contains links between different data items in the data structure; and the rendered screen corresponding to a specific data item comprises an area identifying different data items in the data structure which are linked to the specific data item.

Preferably, the area identifying different data items in the data structure comprises an active area selectable using the user input means to navigate to a rendered screen corresponding to a different data item in the data structure which is linked to the specific data item; and the method further comprises using the user input means to select the active area of the rendered screen of the graphical user interface to navigate to a rendered screen corresponding to the different data item which is linked to the specific data item.

Preferably, the area identifying different data items in the data structure displays a plurality of different data items.

Preferably, the area identifying different data items in the data structure displays a sorted list of different data items.

Preferably, the data store further contains weighting values associated with the links between different data items in the data structure; and the sorted list of data items is sorted in order based, at least in part, on the weighting values associated with the links.

Preferably, the display device is a touch screen device.

Preferably, the touch screen device also acts as the user input means.

According to a third aspect the invention provides an electronic system for providing assemblies of related materials, the system comprising: a processor connected to a data store, a display device, and a user input means; the data store containing a plurality of data items arranged in a data structure; the processor being configured to render a graphical user interface comprising a plurality of separately renderable connected screens on the display device, wherein: the renderable screens of the graphical user interface comprise active areas selectable using the user input means to navigate between connected ones of the renderable screens; the renderable screens being connected in a structure corresponding to the data structure of the plurality of data items; the renderable screens of the graphical user interface comprise active areas selectable using the user input means to enable user selection of data items from the plurality of data items; and the processor being configured to group the selected data items to form an assembly of related materials.

According to a fourth aspect the invention provides a method for providing assemblies of related materials using an electronic system comprising a processor connected to a data store containing a plurality of data items arranged in a data structure, a display device, and a user input means, the method comprising: rendering a graphical user interface comprising a plurality of separately rendered connected screens on the display device, wherein: the rendered screens of the graphical user interface comprise active areas selectable using the user input means to navigate between connected ones of the rendered screens; the rendered screens are connected in a structure corresponding to the data structure of the plurality of data items; and the rendered screens of the graphical user interface comprise active areas selectable using the user input means to enable user selection of data items from the plurality of data items; the method further comprising: using the user input means to select active areas of the rendered screens of the graphical user interface to navigate between connected ones of the rendered screens; using the user input means to select active areas of the rendered screens of the graphical user interface to select data items from the plurality of data items; and grouping the selected data items to form an assembly of related materials.

According to a fifth aspect the invention provides a computer program comprising computer readable instructions which, when executed by a processor, cause the processor to carry out the steps of the method according to any one of the second or fourth aspects.

The invention further provides systems, devices and articles of manufacture for implementing any of the aforementioned aspects of the invention.

### DESCRIPTION OF FIGURES

The invention will now be described in detail with reference to the following figures in which:

FIG. 1 is a diagram of an example of an educational material assembly system according to the invention;

FIG. 2 is a diagram of an example of a structured data store according to the invention;

FIG. 3 is a diagram illustrating examples of subjects according to the invention;

FIG. 4A is a diagram illustrating an example of a first contextual module according to the invention;

FIG. 4B is a diagram illustrating an example of a second contextual module according to the invention;

FIG. 4C is a diagram illustrating an example of a third contextual module according to the invention;

FIG. 5 is a diagram illustrating an example of data items according to the invention;

FIG. 6 is a diagram illustrating an example of a first renderable subject screen of a graphical user interface according to a first embodiment of the invention;

FIG. 7 is a diagram illustrating an example of a second renderable book screen of a graphical user interface according to the first embodiment;

FIG. 8 is a diagram illustrating a first view of an example of a third renderable analysis screen of a graphical user interface according to the first embodiment;

FIG. 9 is a diagram illustrating a second view of the screen of FIG. 8;

FIG. 10 is a diagram illustrating an example of a fourth renderable screen of a graphical user interface according to the first embodiment;

FIG. 11 is a diagram illustrating an example of a content display of a graphical user interface according to the first embodiment;

FIG. 12 is a diagram illustrating a first example of a course builder display of a graphical user interface according to the invention;

FIG. 13 is a diagram illustrating a second example of a course builder display of a graphical user interface according to the invention;

FIG. 14 is a diagram illustrating a third example of a course builder display of a graphical user interface according to the invention;

FIG. 15 is a diagram illustrating a fourth example of a course builder display of a graphical user interface according to the invention;

FIG. 16 is a diagram illustrating an example of a third renderable analysis screen of a graphical user interface according to a second embodiment of the invention;

FIG. 17 is a diagram illustrating an example of a renderable view screen of a graphical user interface according to the invention;

FIG. 18 is a diagram illustrating an example of a first renderable course builder screen of a graphical user interface according to the invention;

FIG. 19 is a diagram illustrating an example of a second renderable course builder screen of a graphical user interface according to the invention;

FIG. 20 is a diagram illustrating an example of a third renderable course builder screen of a graphical user interface according to the invention;

FIG. 21 is a diagram illustrating an example of a fourth renderable course builder screen of a graphical user interface according to the invention;

FIG. 22 is a diagram illustrating an example of a fifth renderable course builder screen of a graphical user interface according to the invention; and

FIG. 23 is a diagram illustrating an example of a sixth renderable course builder screen of a graphical user interface according to the invention.

### DETAILED DESCRIPTION OF THE INVENTION

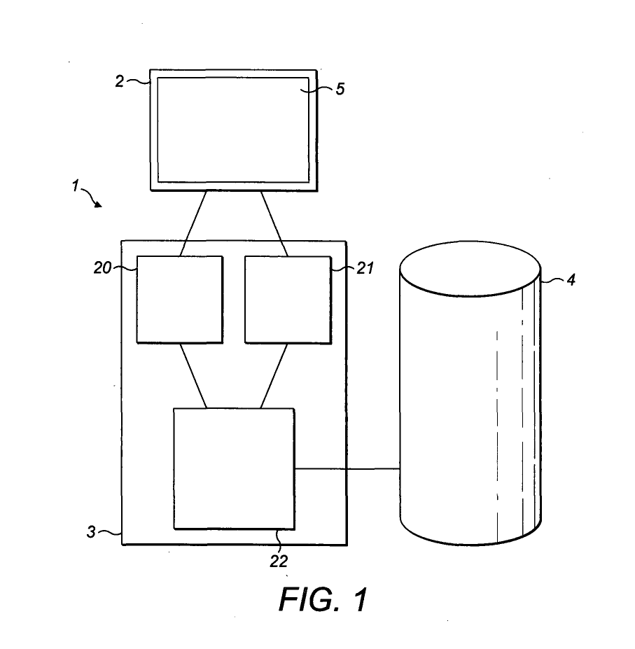

An example of a system for assembling educational materials according to the present application is illustrated in FIG. 1. FIG. 1 shows an exemplary course material assembly system 1 arranged to assemble course materials on behalf of a user. In the example discussed herein the user is an individual academic intending to teach a subject to one or more students and using the assembly system 1 to assemble the necessary course materials. In some examples the user may be an academic assembling course materials to be used by someone else to teach a subject to one or more students, or for self study by one or more students. In some examples the user may be a student using the assembly system 1 to assemble course materials for their own course of study. In some examples the user may be a group of persons collaborating to assemble course materials.

The assembly system 1 is arranged to locate and interconnect educational source materials in response to instructions from the user. The assembly system 1 comprises a visual display 2, a central processing system 3 and a database 4 of available course materials. The functionality of the assembly system 1 may be provided by one or more software applications running on the central processing system 3.

The system can also be used as a browser to navigate through the available course materials and search the available course materials even when users, for example teachers or students, are not assembling course materials.

The central processing system 3 comprises an interface output module 20, which renders a graphical user interface (GUI) 5 on the visual display 2 to allow users to control and operate the system 1, an interface input module 21 allowing a user to input commands and instructions to the assembly system 1 using the GUI 5 on the visual display 2, and a content management module 22.

In the illustrated example the visual display 2 is a touch screen display allowing a user to input commands and instructions to the assembly system 1 by touching the surface of the touch screen of the visual display 2. Accordingly, the interface output module 20 and the interface input module 21 are both connected to the visual display 2. In one example the visual display 2 may be a touch screen display able to detect multiple touches across the touch screen. In one example the visual display 2 may be a touch screen using optical sensors to detect a user touch on the touch screen. In other examples, different forms of touch screen may be used.

In some examples the visual display 2 may be a multi-touch display. In one example the visual display 2 may be a multi-touch table display. Such a table display provides a relatively large, horizontal touch screen. The provision of a multi-touch capability and the large horizontal touch screen may both be advantageous in situations where multiple users are cooperating to assemble the course materials, allowing the users to conveniently sit or stand around the touch screen, allowing easy access to, and visibility of, the touch screen to all of the users, and permitting convenient discussion and interaction between the users.

In other examples different forms of touch screen device may be used. In some examples mobile touch screen devices may be used, for example tablet computers or smartphones.

In some examples the system may be remotely accessed through a communications network such as the Internet.

The database 4 contains a structured store 6 of available course materials which may be accessed by the content management module 22. In the illustrated embodiment the structured store 6 stores the course materials in a hierarchical data structure. The available course materials are stored in the database 4 as a plurality of data items and a plurality of links connecting different data items, which may also be referred to as content items. In one example the links are defined by tags stored in association with the data items, which tags can be used by the content management module 22 to identify links between different data items. The principles of storing and accessing data using links defined by tags associated with the data are well known and need not be discussed in detail in the present application.

The database 4 contains both the raw data making up the data items, for example text, images and audio and video clips, and metadata relating to the data items, for example author names, data item titles, and links. These lists are exemplary only and are not intended to be exclusive.

The database 4 is shown as a single item in FIG. 1 for clarity. However, in some examples the database 4 may comprise a storage facility to store the data items themselves and a separate database storing the tags, structure and relations linking the data items. In some examples this may be considered as the storage facility storing the raw data, while the separate database stores the metadata relating to the raw data. This may provide advantages in practice because the characteristics of the raw data and the metadata may be different, the raw data may be larger in size but seldom changing, while the metadata may be smaller in size but subject to rapid change. Accordingly, the use of separate data storage elements may allow the separate data storage elements to be matched to the characteristics of the respective stored data.

In some examples the database 4 may be hosted by an internet cloud service. In such examples a local database may additionally be provided as a part of the assembly system 1 to act as a cache storing data which has recently been retrieved from or saved to the cache by a user. This may allow access times to regularly accessed data to be minimized, since it is likely that a user assembling a course of study may access the same data repeatedly.

In some examples the database 4 may be associated with the assembly system 1. In some examples where the visual display 2 is a multi-touch table display the central processor 3 and the database 4 may both be integrated into the table display. Local storage of the data items ensures quick and reliable access, and may help to keep the data items secure from unauthorized access and/or alteration.

In some examples some data items may be stored remotely, for example on a remote server, and accessed as necessary through a communications network such as the Internet. This may be desirable if some data items are relatively large, for example video data, in order to avoid excessive storage demands on the local database. In some examples this remote server may be hosted by an internet cloud service.

In some examples the database 4 may be a local database updated from a remote central parent database. In these examples the data in the central database may be changed or added to and the changes distributed to the, or each, local database 4 as necessary.

The provision of such a local database 4 may be useful in examples where the assembly system is shared by a number of users operating as a group. For example, where a group is collaborating to assemble a course using a multi-touch table display.

The graphical user interface 5 comprises a plurality of interlinked navigable screens allowing a user to control all of the functions of the assembly system 1. In particular, the plurality of interlinked navigable screens allow a user to access all of the course materials in the structured store 6 in a logical and intuitive manner, and to view and define the relationships between the different data items of the course materials in the structured store 6. As will be explained in more detail below the user can navigate between the different ones of the plurality of interlinked navigable screens, which are connected together in a structure corresponding to the structure in which the data items are stored in the structured store 6. In other words, the structure of the plurality of interlinked navigable screens mirrors, or follows, the structure of the stored data items. Accordingly, in the illustrated embodiment the interlinked navigable screens are connected in a hierarchical structure corresponding to the hierarchical data structure used to store the course materials.

This use of the plurality of interlinked navigable screens to allow a user to access the contents of the structured store is particularly advantageous when combined with the use of a touchscreen to access and control the assembly system 1 because this allows intuitive handling of the data items, as if the users are touching or handling the actual data items themselves.

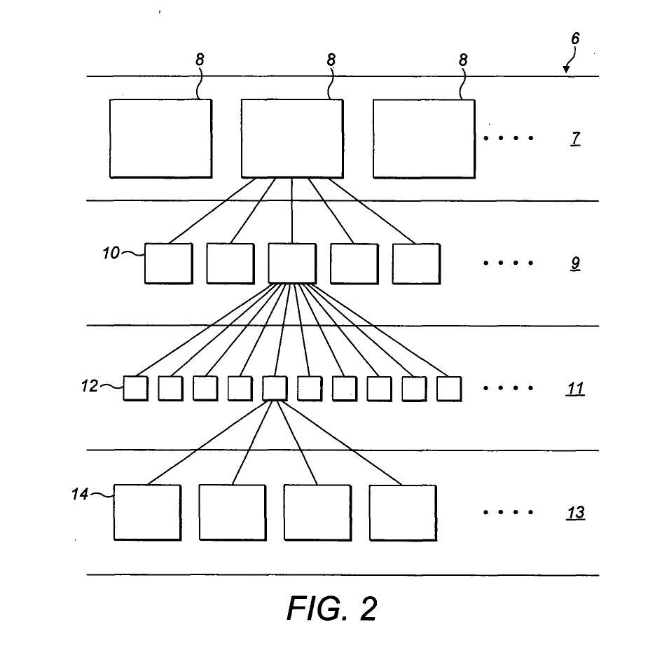

As explained above, the database 4 contains a structured store 6 of available course materials. The hierarchical structure of this structured store 6 is illustrated in FIG. 2.

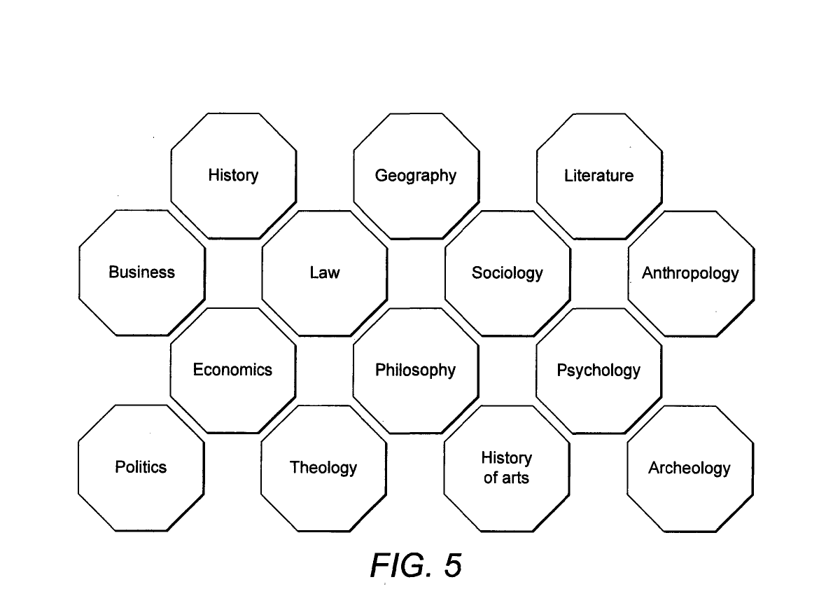

A first, or highest, level, of the structured store 6 is the subject level 7. In the subject level 7 the available course materials are divided into different subjects 8. In the illustrated example the course materials relate to education in the fields of humanities, arts and social sciences. The different subjects 8 are generally recognized subjects, such as history, law, archeology, and the like. Only three subjects are shown in the example of FIG. 2. The full set of fourteen subjects 8 in the illustrated example is shown in FIG. 3, in which the fourteen subjects are different social sciences. In other examples the subjects may be drawn from different, or additional, fields, and there may be a different number of subjects. It will be understood that these examples are not exhaustive, and are not intended to be limiting.

A second, or next lower, level of the structured store 6 is the book level 9. In the book level 9 a number of topics or books 10 are linked to each of the subjects 8 in the subject level 7. The number of books 10 identified as being linked to each subject 8 may be relatively large. In one example four hundred books 10 are identified as being linked to each of the subjects 8. In other examples a different number of books may be identified as being linked to each of the subjects 8. In some examples different subjects 8 may have different numbers of linked books 10. In order to provide the best assembly of educational materials the books 10 should be selected as the seminal, or most important and/or significant books associated with and/or related to the subject 8, although this choice is of course a subjective matter.

A third, or next lower, level of the structured store 6 is the analysis level 11. In the analysis level 11 a set of analyses 12 are linked to each of the books 10 in the book level 9. In the illustrated example there is a set of twenty seven analyses 12 linked to each of the books 10 in the book level 9. Each of the analyses 12 presents an analysis of the respective linked book 10 based on a different theme or aspect of the linked book 10. It should be noted that the analyses 12 are not parts or sections of the linked books 10 such as chapters of the linked books 10. Details of the contents of the analyses 12 are discussed below.

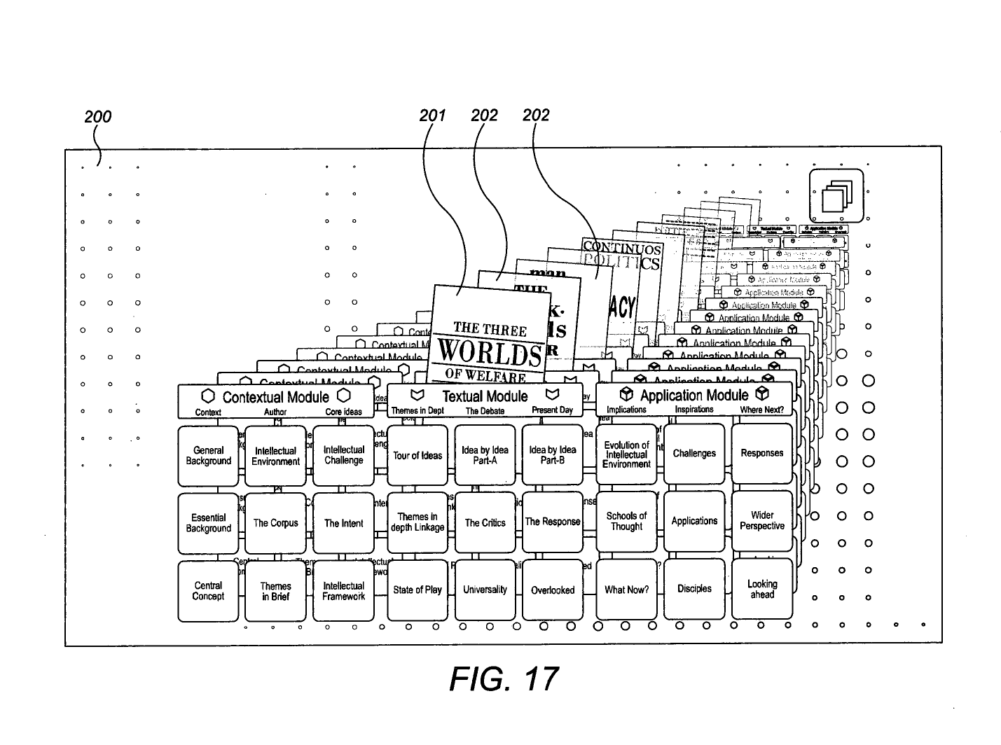

It is preferred that the analyses 12 relating to each of the books 10 are generated and presented according to a consistent common arrangement defining the basis on which of each of the analyses 12 is derived from the book 10 and related issues such as the context and impact of the book 10. As a result, all of the books 10 are linked to a set of analyses 12 wherein the corresponding analyses of different books 10 each provide a consistent analysis of their respective book 10 from the same defined point of view. This may provide the advantage that users can readily use the different analyses to directly compare the same aspects or facets of a number of different books in a consistent manner. A display showing these relationships in graphical form is shown in FIG. 17, which is discussed below.

In the illustrated example the analyses 12 relating to each book 10 examine three different facets of the book 10: the context in which the book 10 was written; the actual content of the book 10, such as the key ideas of the book 10 and their significance; and the impact that the book 10 has had.

In the illustrated example the twenty seven analyses 12 relating to a specific linked book 10 can be regarded as being grouped into three groups or sets each relating to a different one of the facets of context, content and significance. Further, the twenty seven analyses 12 can be regarded as being grouped into nine modules 15, with each facet set grouping together three modules 15 and each module 15 grouping together three analyses 12. Thus, the nine modules 15 can be regarded as being grouped into three sets of modules 15, with each set grouping together three modules 15, and so grouping together the nine analyses 12 making up the three modules 15. In the illustrated example the grouping of the analyses 12 into modules 15 and sets is not of any significance regarding the data structures and links within the structured store 6, but is helpful to guide and assist a user in locating and assembling the desired course materials.

In other examples the grouping of the analyses 12 into the hierarchy of sets, modules and analyses may be reflected by the structure of the interlinked navigable screens.

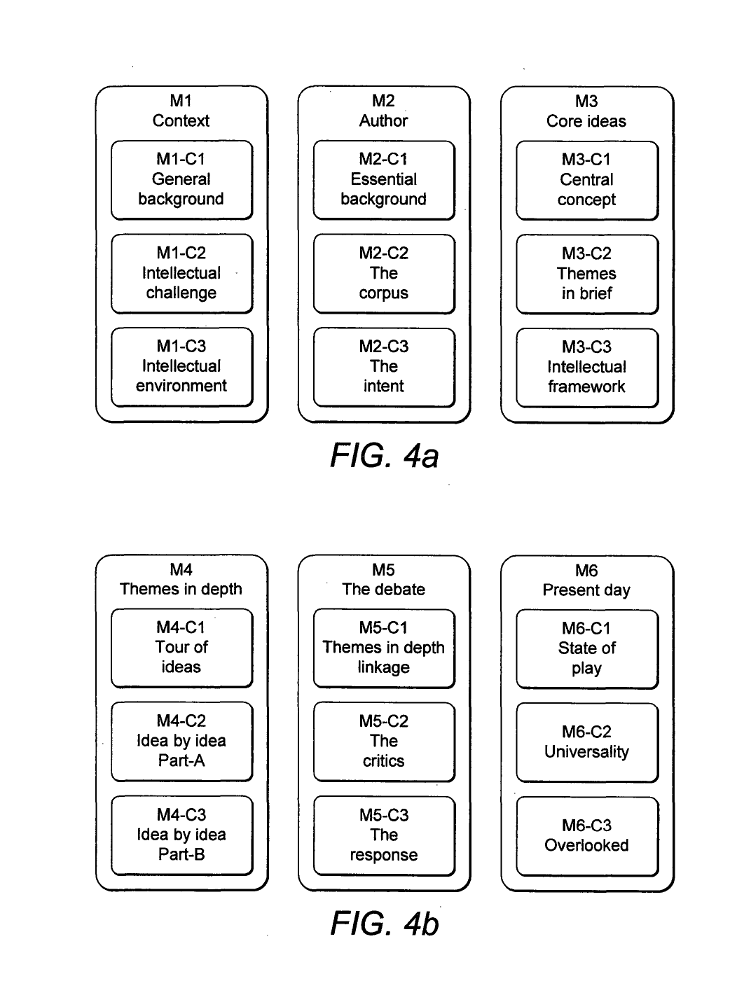

The three sets, nine modules 15 and the twenty seven analyses 12 are illustrated in FIGS. 4A to 4C.

FIG. 4A shows a first context set. The context set comprises: a context module comprising a general background analysis, an intellectual challenge analysis, and an intellectual environment analysis; an author module comprising an essential background analysis, a corpus analysis, and an intent analysis; and a core ideas module comprising a central concept analysis, a themes in brief analysis, and an intellectual framework analysis.

FIG. 4B shows a second content set. The content set comprises: a themes in depth module comprising a tour of ideas analysis, a first idea by idea analysis, and a second idea by idea analysis; a debate module comprising a themes in depth linkage analysis, a critics analysis, and a response analysis; and a present day module comprising a state of play analysis, a universality analysis, and an overlooked analysis.

FIG. 4C shows a third significance set. The significance set comprises: an implications module comprising an evolution of intellectual environment analysis, a challenges analysis, and a responses analysis; an inspirations module comprising a schools of thought analysis, an applications analysis, and a wider perspectives analysis; and a where next module comprising a what now analysis, a disciples analysis, and a looking ahead analysis.

In other examples different analyses 12 and/or a different number of analyses 12 may be used.

In one alternative example the context set may comprise a context module comprising a general background analysis, an intellectual challenge analysis, and an intellectual environment analysis; an author module comprising an authors influences analysis, a corpus analysis, and an intent analysis; and a core ideas module comprising a core concept analysis, a themes in brief analysis, and an intellectual framework analysis; the content set may comprise: a themes in depth module comprising a tour of ideas analysis, a superordinate idea analysis, and a subordinate idea analysis; a debate module comprising a linkage analysis, a critics analysis, and a response analysis; and a present day module comprising a state of play analysis, a universality analysis, and an overlooked analysis; and a significance set comprising: an implications module comprising an evolution of intellectual environment analysis, a challenges analysis, and a responses analysis; an inspirations module comprising a schools of thought analysis, an applications analysis, and a wider perspectives analysis; and a where next module comprising a potential analysis, a disciples analysis, and a summary analysis.

In other examples different context modules and/or different sets may be used to group the analyses 12 together.

In the illustrated embodiment the individual data items stored in the structured store 6 which may be selected and grouped by the content management module 22 to form the desired educational course materials are referred to as “lexicons” 14.

Accordingly, a fourth, or lowest, level of the structured store 6 is referred to as the lexicon level 13. In the lexicon level 13 four lexicons 14 are linked to each of the analyses 12 in the analysis level 11. Each of the lexicons 14 discusses the aspect of the linked analysis 12 relating to the linked book 10 from a different perspective and in a different manner.

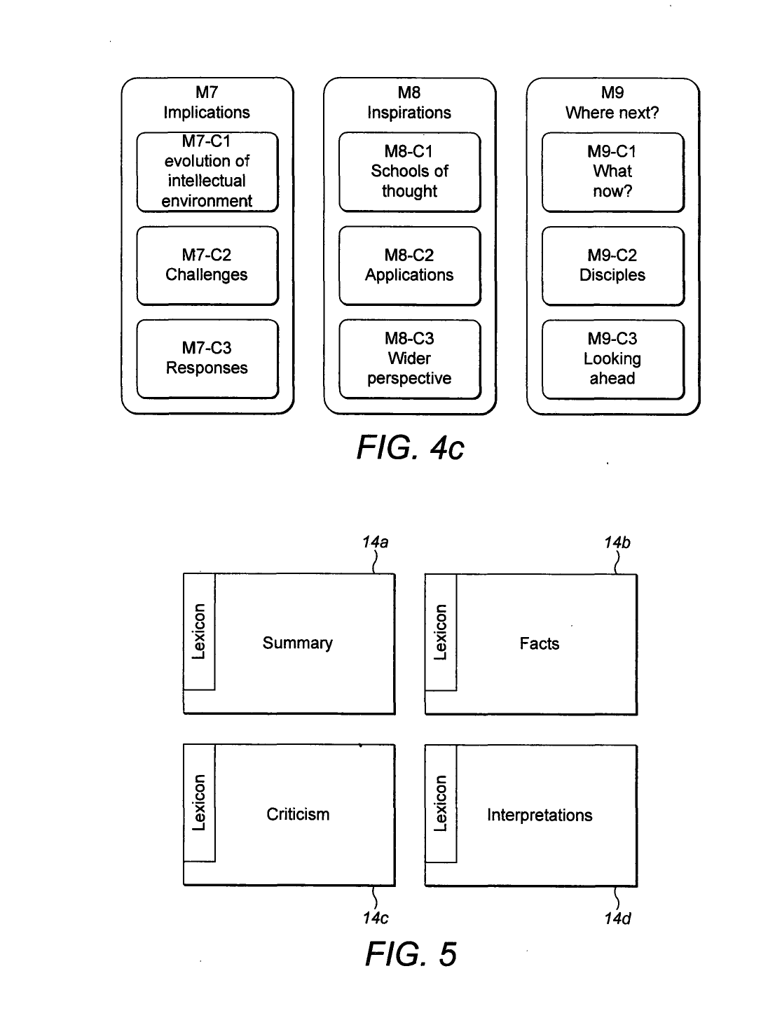

FIG. 5 shows the four lexicons 14 linked to a particular, or specific, analysis 12. The lexicons comprise a summary lexicon 14a, a facts lexicon 14b, a criticism lexicon 14c, and an interpretations lexicon 14d. The facts lexicon 14b presents the facts forming the content of the analysis 12. The interpretations lexicon 14d presents an interpretation and explanation of the facts. The criticism lexicon 14c presents critical responses to the facts. The summary lexicon 14a presents a summary of the contents of the other lexicons 14b to 14d. As explained above, in the illustrated embodiment the lexicons 14 are the data items which may be selected and grouped by the content management module 22 to form the desired educational course materials. In this embodiment, although a lexicon may include a number of separate texts or other data items the different texts making up a lexicon 14 cannot be separated and individually selected and grouped by the content management module 22.

The provision of multiple lexicons 14 relating to each analysis 12 enables learners to develop their critical thinking skills by considering different aspects of the subject of the analysis 12 in a manner that is not readily done with more conventional methods of presenting information. Further, by selecting different lexicons 12 a user can produce course materials better suited to students at different levels of knowledge about a subject. Further, by including different lexicons 12 in the materials for a course of study a user can integrate the teaching of critical thinking skills into the course by providing progressively more critical materials on the same analysis 12.

In some examples some or all of the lexicons 14 may be presented at a number of different levels of complexity and detail in order to allow courses to be tailored to individuals with different requirements and/or intellectual abilities.

As discussed above each lexicon may comprise text. In some examples, some or all of the lexicons could include or comprise other data items such as images, video footage, sound recording, or multi-media presentations.

In other examples it may be possible to separately select and group individual texts from a lexicon 14. In other examples each lexicon 14 may only include a single text.

As can be understood from the above description, each of the lexicons 14 will be linked to a single corresponding analysis 12 and to a single corresponding book 10. The content of each of the lexicons 14 comprises text based upon the corresponding book 10, taking into account the theme of the corresponding analysis 12.

The form of the hierarchical data structure of the structured store 6 as described above may be regarded as recursive atomizing, in that the structure is one in which each higher level entity in the structure is split into smaller entities, which are split in turn into yet smaller entities, and so on, until the lowest level of the structure is reached.

The structured store 6 may contain a total number of data items as required to support the desired courses in any specific implementation. In one example the structured store 6 may contain over 500,000 content items.

As explained above the graphical user interface (GUI) 5 comprises a plurality of connected screens which can be selectively rendered on the visual display 2 by the interface output module 20, and the plurality of connected screens are connected in a structure corresponding to the structure of the data items in the structured store 6.

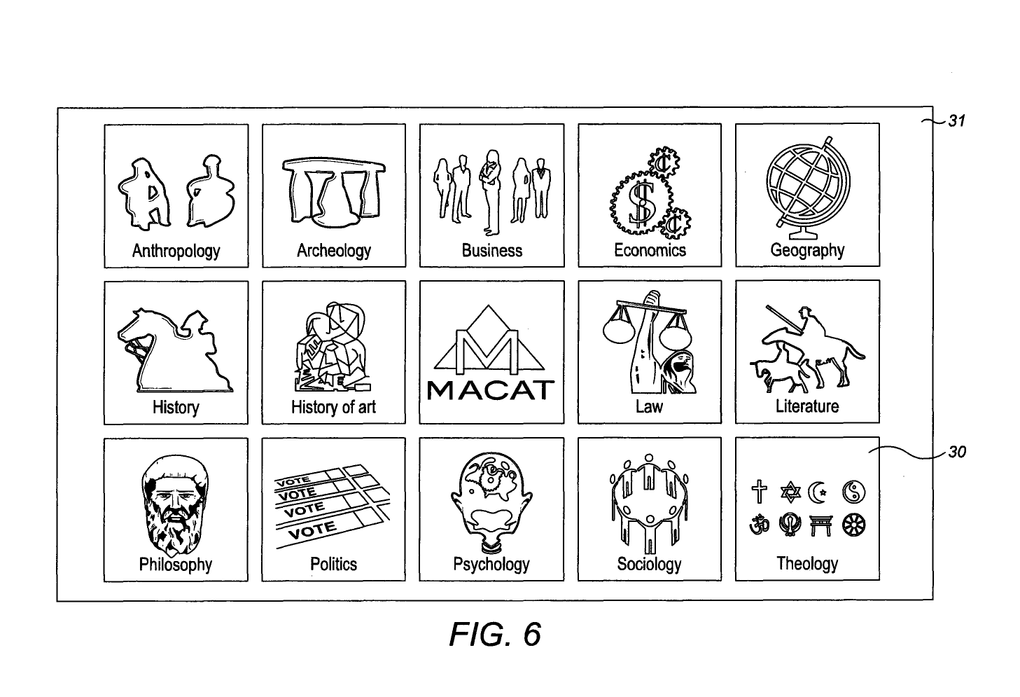

This hierarchical structure of renderable screens will now be described with reference to FIGS. 6 to 11.

A first, or highest level, subject screen 30 of the GUI is shown in FIG. 6. The first level screen 30 comprises a plurality of active or sensitive regions which respond to user touch input through the interface input module 21. The active regions comprise a plurality of subject selection areas 31 corresponding to a different one of the subjects 8 in the first, subject level 7 of the structured store 6. In the illustrated example there are fourteen active subject selection areas 31 each corresponding to a respective one of the set of fourteen subjects shown in FIG. 3. Each of the active subject selection areas 31 is marked by a name of the corresponding subject and an intuitive logo relating to the subject to guide user selection. The assembly system 1 responds to a user touch on one of the active subject selection areas 31 by rendering a different second level screen, as will be discussed below.

Although the first level subject screen 30 shown in FIG. 6 is the highest level screen in the hierarchical structure of renderable screens, there may be further related screens renderable as part of the GUI to start or control operation of the system 1. For example, where the functionality of the assembly system 1 is provided by a software application, there may be a start up screen to activate the application. Further, there may be a log in screen controlling access to the application, for example by requiring input of a user identifier, such as a password. Such related screens, such as a start up screen and/or a log in screen, are not regarded as part of the plurality of connected screens. These related screens may allow, or control, access to the assembly system 1, but they do not control the selection of course materials by the assembly system 1. As a result, it is not necessary for arrangement of these related screens to correspond to the structure of the structured store.

In addition to the active subject selection areas 31 the first level subject screen 30 may include further active areas providing access to further functionality of the assembly system 1. In the illustrated example the first level subject screen 30 includes a further active area 31a marked by the system name allowing a user to leave, or close, the assembly system 1. In other examples a control or controls allowing a user to leave or close the system may be located elsewhere, in addition to, or as an alternative to, the first level subject screen 30. In other examples further active areas may allow access to a help function, a dictionary or glossary, a language selection function, and the like.

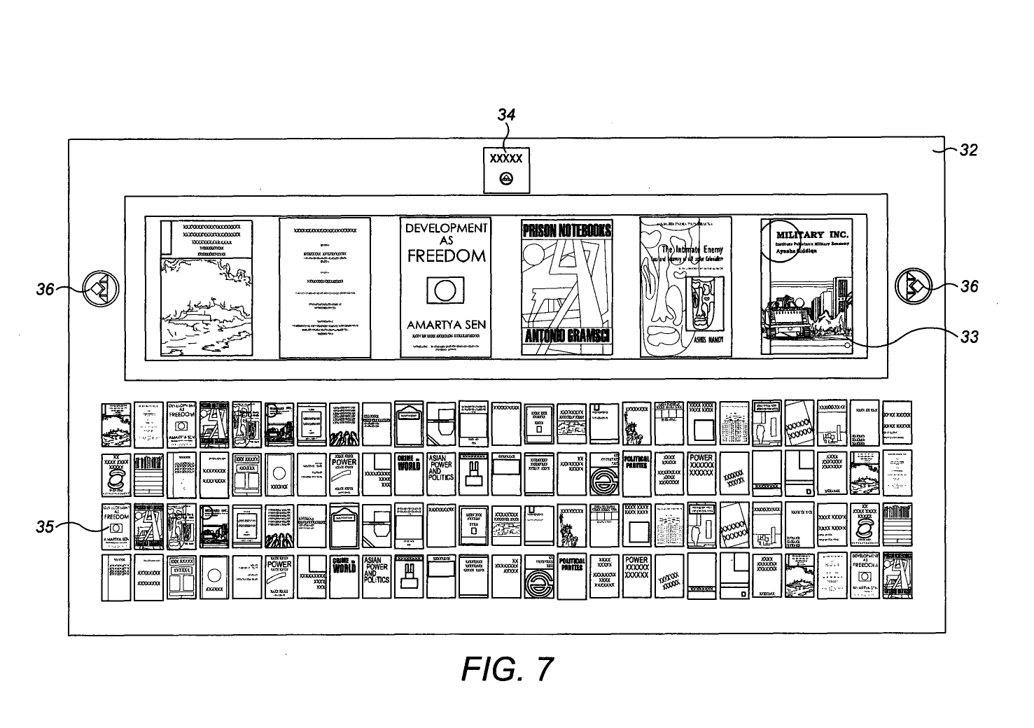

A second, or next lower, level book screen 32 of the GUI 5 is shown in FIG. 7. A second level book screen 32 is rendered in response to a touch on an active subject selection area 31 of the first level subject screen 30 of FIG. 6. There are a plurality of second level book screens 32, each second level book screen 32 being rendered in response to a user touch on a different one of the active subject selection areas 31 of the first level subject screen 30, and corresponding to the subject 8 of that active subject selection area 31. Each second level book screen 32 displays the books 10 identified as being linked to the corresponding subject 8 in the second, book level 9 of the structured store 6. In the illustrated example there are fourteen second level book screens 32 each corresponding to a respective one of the set of fourteen subjects shown in FIG. 3.

The second level book screen 32 corresponding to a particular, or specific, subject 8 comprises a plurality of active or sensitive regions which respond to user touch input through the interface input module 21. The active regions comprise a plurality of active book selection areas 33 corresponding to different ones of the books 10 linked to the particular subject 8 in the second, book level 9 of the structured store 6.

In the illustrated example there are six active book selection areas 33. Each active book selection area 33 is rendered as an icon showing a thumbnail view of the cover of the corresponding book 10. The active book selection areas 33 are arranged in a scrolling display area 34 which is rendered to respond to a moving user touch in the scrolling display area 34 by moving the active book selection areas 33 and thumbnail views in the direction of the moving user touch so that the scrolling display area 34 appears to be scrolling in order through the plurality of books 10 linked to the particular subject 8 in a direction indicated by the moving user touch. As the scrolling takes place the correspondence of the active book selection areas 33 to the books 10 will change and corresponding changes to the displayed thumbnail views are made, to allow all of the books 10 linked to the particular subject 8 to be displayed and made available for selection using the active book selection areas 33.

The assembly system 1 responds to a user touch on one of the active book selection areas 33 by rendering a different third level screen, as will be discussed below.

The second level book screen 32 also includes an active return area 34. The assembly system 1 responds to a user touch on the active return area 34 by rendering the first level subject screen 30. In some examples the active return area 34 may be marked by the name and/or logo relating to the subject 8 in the first, subject level 7, to which the displayed second level book screen is linked.

The second level book screen 32 also includes a book display area 35 showing thumbnail views of the covers of all of the books 10 linked to the particular subject to provide guidance to a user what books 10 are available for selection using the active book selection areas 33. The book display area 35 comprises active scroll jump areas. The assembly system 1 responds to a user touch on one of the active scroll jump areas by jumping, or skipping, the books 10 displayed in the scrolling display area 34 to correspond to those shown at the touched location.

The second level book screen 32 also includes a pair of active scrolling control areas 36 displayed as directional arrows pointing in opposite directions. The assembly system 1 responds to a user touch on an active scrolling control area 36 by moving the active book selection areas 33 and thumbnail views in the direction indicated by the corresponding displayed directional arrow so that the scrolling display area 34 appears to be scrolling in order through the plurality of books 10 in the direction of that arrow.

In other examples the scrolling of the active book selection areas may be controlled in other ways. In some examples the active book selection areas may be arranged to scroll through the available books in two dimensions. In some examples the number of active book selection areas may be changed. In some examples the thumbnail views in the book display area 35 may also be active areas allowing books to be selected by a user touch.

In some examples the total number of available books may be too large to conveniently display as thumbnails in the book display area 35 and only a portion of the available books may be displayed in the book display area 35 at one time. In such examples some means for changing which portion of the available books are displayed in the book display area 35 should be provided.

In addition to the active areas discussed above the second level book screen 32 may include further active areas, not shown in FIG. 7, providing access to further functionality of the assembly system 1.

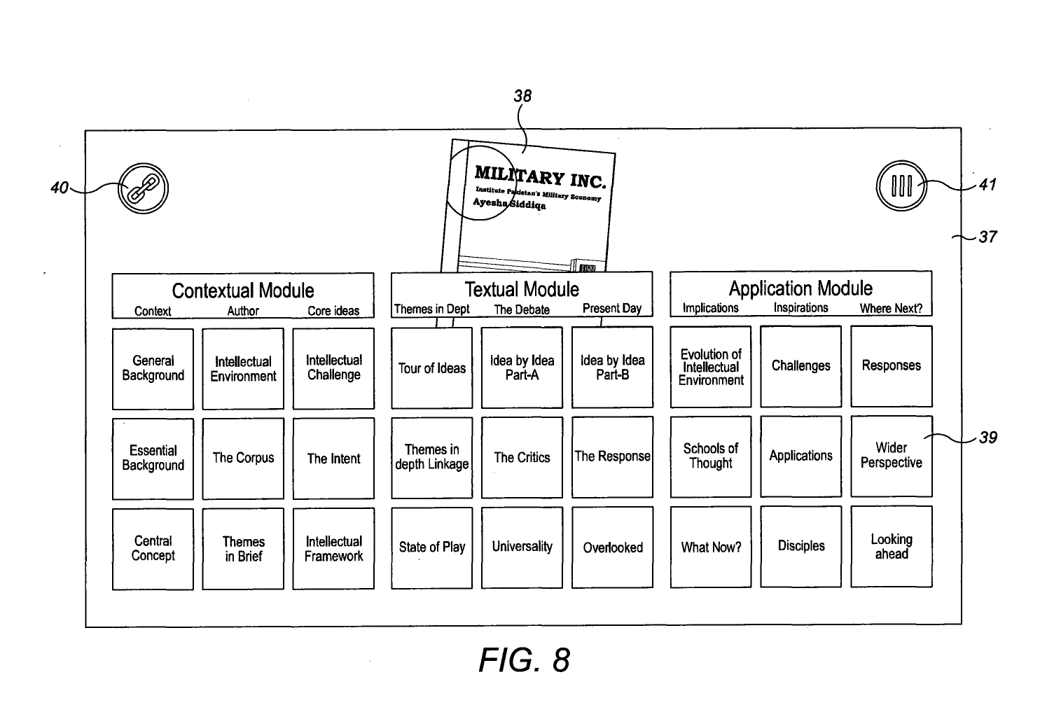

The third, or next lower, level analysis screen 37 of the GUI 5 is shown in FIG. 8. A third level analysis screen 37 is rendered in response to a touch on an active book selection area 33 of the second level book screen 32. There are a plurality of third level analysis screens 37, each third level analysis screen 37 being rendered in response to a user touch on an active book selection area 33 of the second level book screen 32 corresponding to a different book 10. As explained above, the active book selection areas 33 of the second level book screen may correspond to different books 10 at different times, so which third level screen 37 is rendered depends upon the identity of the corresponding book 10 at the time of a user touch, and not directly on which active book selection area 33 is touched.

The third level analysis screen 37 corresponding to a particular, or specific, book 10 includes an active return area 38. The assembly system 1 will respond to a user touch on the active return area 38 by returning to the second level book screen 32 with which the specific third level analysis screen 37 is linked, that is the second level book screen 32 from which the third level analysis screen 37 can be reached through an active book selection area. In the illustrated example the active return area 38 is identified with a thumbnail image of the cover of the particular book 10. In addition to identifying the active return area 38, this thumbnail may provide a user reminder of the particular book to which the third level analysis screen relates.

Each third level analysis screen 37 corresponding to a particular book 10 comprises a plurality of active analysis selection areas 39 each corresponding to a different one of the analyses 12 in the third, analysis level 11 of the structured store 6, which are linked to the particular book 10. The assembly system 1 responds to a user touch on one of the active analysis selection areas 39 by rendering a different fourth level screen, as will be discussed below.

In the illustrated example there are twenty seven active analysis selection areas 39 each corresponding to a respective one of the set of twenty seven analyses 12 shown in FIGS. 2 and 4a to 4c. Each of the active analysis selection areas 39 is marked with the title of the corresponding analysis to guide user selection. The active analysis selection areas 39 are rendered and displayed grouped together in the sets and modules 15 discussed above regarding the structured store 6. In general, the grouping of the analyses 12 into modules 15 and sets is not of any significance regarding the data structures and links within the structured store 6, but is helpful to guide and assist a user in locating and assembling the desired course materials.

The third level analysis screen 37 also includes an active links control area 40 marked with a linking symbol. The assembly system 1 responds to a touch on the active links control area 40 by displaying books linked to the particular book 10 in a scrolling linked item display area 42.

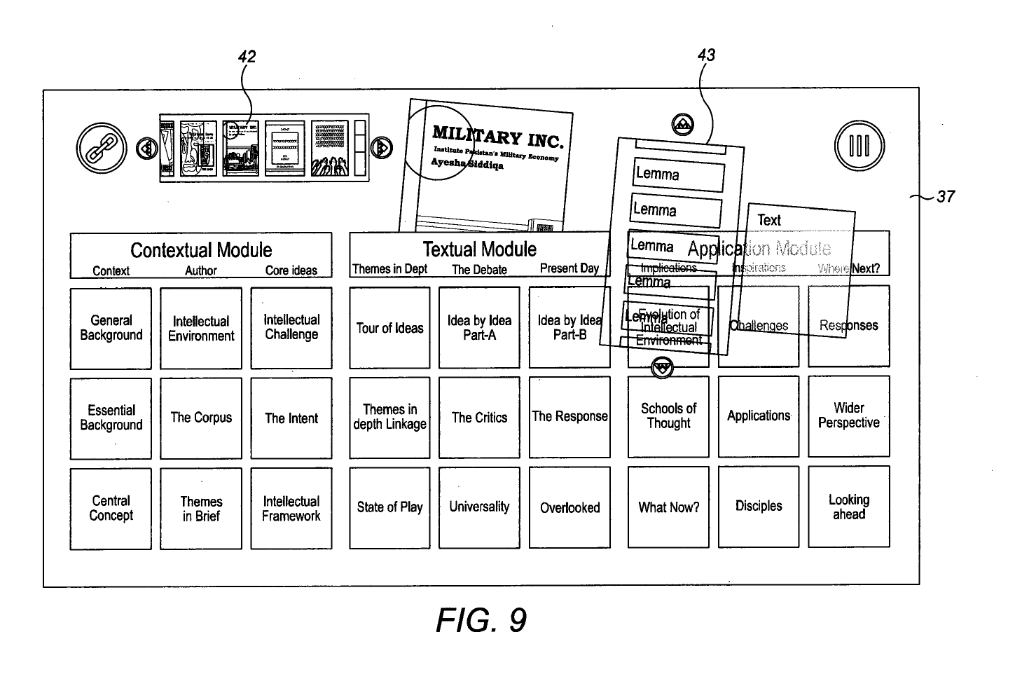

The third level analysis screen 37 of the GUI 5 is shown in FIG. 9 with the scrolling linked item display area 42 on display. The scrolling linked item display area 42 comprises a plurality of active linked item selection areas marked with icons showing thumbnail views of the covers of the corresponding linked books. When the number of linked books is greater than the number of active linked item selection areas the scrolling linked item display area 42 can be scrolled in response to a user touch in order to display different ones of the linked books.

The assembly system 1 responds to a user touch on an active linked item selection area by displaying a different third level analysis screen 37 corresponding to the linked book 10 identified with the touched active linked item selection area.

The third level analysis screen 37 also includes an active glossary control area 41 marked with an icon. The assembly system 1 responds to a touch on the active glossary control area 41 by displaying terms, such as words and phrases relating to the particular book 10, and their meanings, in a scrolling glossary display area 43. The scrolling glossary display area 42 comprises a plurality of active glossary term selection areas marked with the glossary terms.

The assembly system 1 responds to a user touch on an active glossary term selection area in the scrolling glossary display area 43 by displaying the meaning of the glossary term corresponding to the touched active glossary term selection area.

The third level analysis screen 37 of the GUI 5 is shown in FIG. 9 with the scrolling glossary display area 43 and the meaning of a glossary term on display.

Similarly to the scrolling display area of the second level book screen 32 the scrolling linked item display area 42 and the scrolling glossary display area 43 are moved by the assembly system 1 in response to a moving user touch, and the displayed items changed, in order to scroll through the available linked items and glossary terms respectively.

In addition to the active areas discussed above the third level analysis screen 37 may include further active areas, not shown in FIGS. 8 and 9, providing access to further functionality of the assembly system 1.

In some examples such further active areas may provide access to a trailer providing an introduction to the book and/or a summary or discussion about the book. Such an introduction, summary or discussion may be provided as text or in other formats such as audio. In some examples they may be provided in a downloadable form, for example an audio podcast. In some examples they may be offered as streaming media.

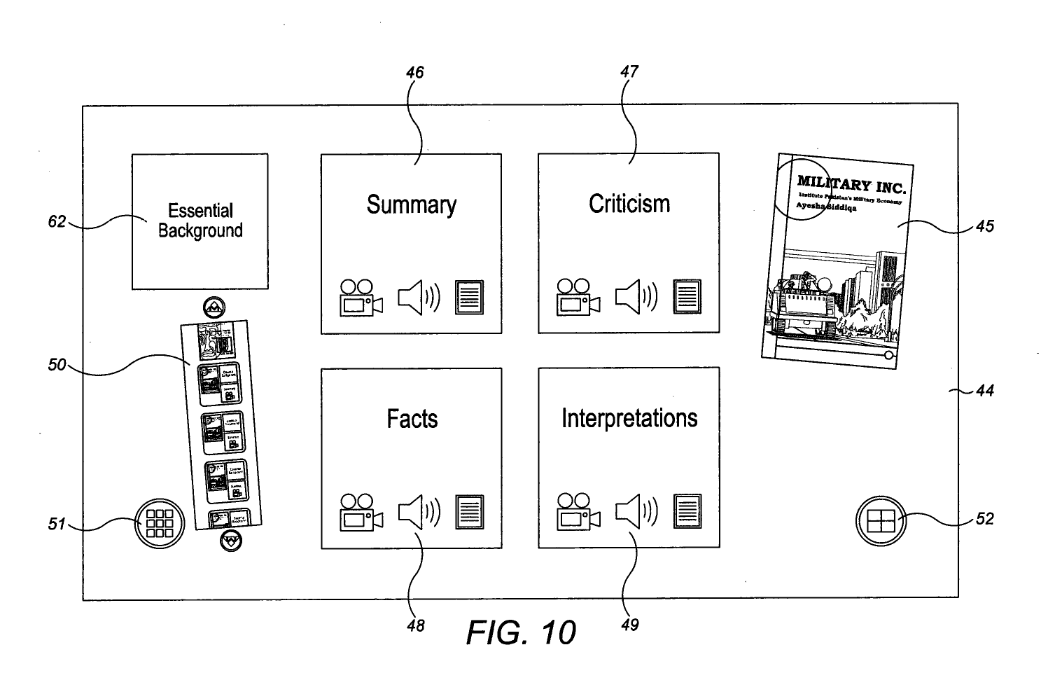

The fourth, or lowest, level lexicon screen 44 of the GUI 5 is shown in FIG. 10. A fourth level lexicon screen 44 is rendered in response to a touch on an active analysis selection area 39 of the third level analysis screen 37. There are a plurality of fourth level lexicon screens 37, each fourth level lexicon screen 44 being rendered in response to a user touch on an active analysis selection area 39 of the third level analysis screen 37 corresponding to a different analysis 12.

The fourth level lexicon screen 44 corresponding to a particular analysis 12 includes an active return area 62. The assembly system 1 will respond to a user touch on the active return area 62 by returning to the third level analysis screen 37 with which the specific fourth level lexicon screen 44 is linked, that is the third level analysis screen 37 from which the fourth level lexicon screen 44 can be reached through an active analysis selection area. In the illustrated example the active return area 62 is identified with the name of the analysis 12. In addition to identifying the active return area 62, this may provide a user reminder of the particular analysis to which the fourth level lexicon screen 44 relates.

The fourth level lexicon screen 44 also includes a thumbnail image 45 of the cover of the particular book 10 to which the particular analysis 12 and the fourth level lexicon screen 44 relate, this may provide a user reminder of the particular book to which the particular analysis and the fourth level lexicon screen 44 relate, and assist in preventing the user from losing track of their position in the data structure and effectively becoming lost.

Each fourth level lexicon screen 44 corresponding to a particular analysis 12 comprises a plurality of active lexicon selection areas 46 to 49 each corresponding to a different one of the lexicons 14 in the fourth, lexicon level 13 of the structured store 6, which are linked to the particular analysis 12. The assembly system 1 responds to a user touch on one of the active lexicon selection areas 46 to 49 by rendering a different content display screen, as will be discussed below.

In the illustrated example there are four active lexicon selection areas 46 to 49, each corresponding to a respective one of the set of four lexicons 14 shown in FIGS. 2 and 5. Each of the active lexicon selection areas 46 to 49 is marked with the title of the corresponding lexicon to guide user selection.

The fourth level lexicon screen 44 also includes an active links control area 51 marked with a linking symbol. The assembly system 1 responds to a touch on the active links control area 51 by displaying a plurality of analyses linked to the particular analysis 12 in a scrolling linked item display area 50. The scrolling linked item display area 50 comprises a plurality of active linked item selection areas marked with icons showing thumbnail views of the corresponding linked analyses. When the number of linked analyses is greater than the number of active linked item selection areas the scrolling linked item display area 50 can be scrolled in response to a user touch in order to display different ones of the linked analyses.

The fourth level analysis screen 44 of the GUI 5 is shown in FIG. 10 with the scrolling linked item display area 56 on display. This will not always be the case. The scrolling linked item display area 56 is displayed selectively under user control.

The assembly system 1 responds to a user touch on an active linked item selection area by displaying a different fourth level analysis screen 44 corresponding to the linked analysis 12 identified with the touched active linked item selection area.

In addition to the active areas discussed above the fourth level lexicon screen 44 may include further active areas, not shown in FIG. 10, providing access to further functionality of the assembly system 1. In some examples the fourth level lexicon screen 44 may include a glossary.

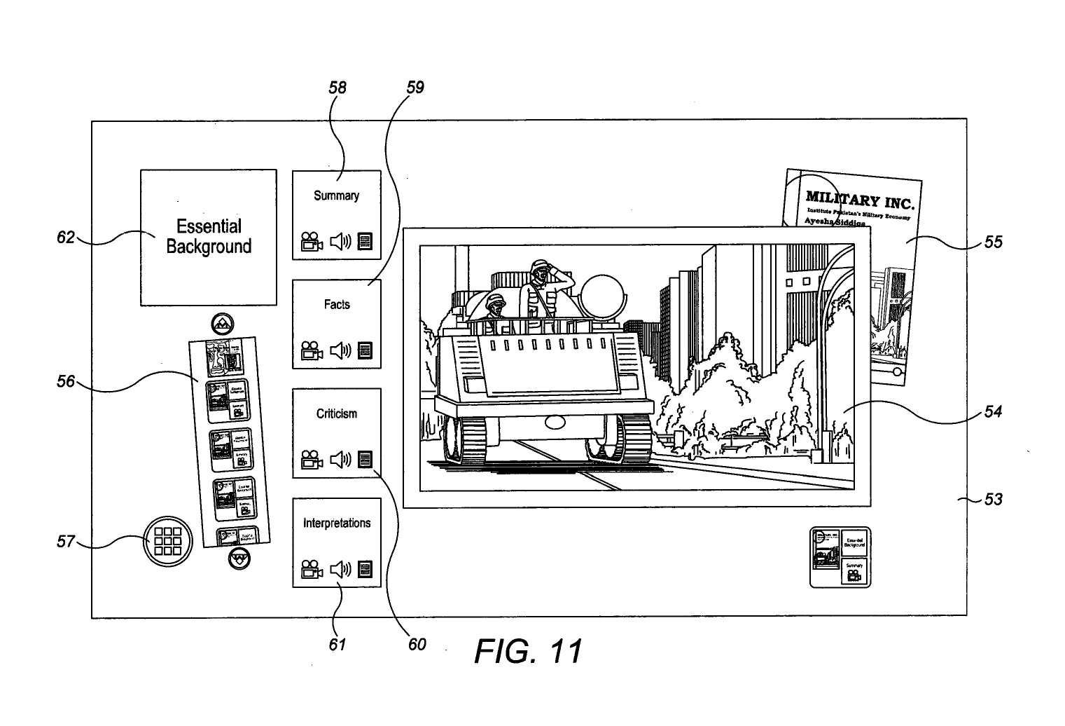

The content display screen 53 is shown in FIG. 11. The content display screen 53 is rendered in response to a touch on an active lexicon selection area 46 to 49. The content display screen 53 has a display area 54 displaying the content comprised in the particular lexicon 14 corresponding to the touched active lexicon selection area 46 to 49.

In addition the content display screen 53 has the same functionality as the fourth level lexicon screen 44. However, the active display areas of the content display screen 53 are relocated and generally reduced in size in order to provide sufficient screen space for the display area 54.

In the illustrated example the content display screen 53 comprises an active return area 63, a thumbnail image 55 of the cover of the particular book 10 to which the particular analysis 12, the fourth level lexicon screen 44, and the content display screen 53 relate, a plurality of active lexicon selection areas 58 to 61, an active links control area 57 and a scrolling linked item display area 56, which provide the same functionality as the corresponding components of the fourth level lexicon screen 44.

As noted above, the content display screen 53 of FIG. 11 has substantially the same functionality as the lexicon screen 44 of FIG. 10 together with an additional display area 54.

In some alternative examples a full screen display mode may be available in addition to, or instead of, the content display screen 53. In such a full screen display mode all, or substantially all, of the display area of the screen is used to display the selected content. Such a full screen display may include suitable control areas to allow access to the selected content to be controlled by the user, and to allow a user to leave the full screen display mode and return to the lexicon screen 44 and/or the content display screen 53. Further, the full screen display may respond to user gesture type touch movements on the display screen.

Where a full screen display mode is available the lexicon screen 44 and/or the content display screen 53 may include suitable control areas to allow a user to enter the full screen display mode. In one example a user may command the system to change between the content display screen 53 and a full screen display mode by making an “expand” or “contract” movement gesture on the screen corresponding to the respective expansion or contraction of the size displayed content.

In the illustrated example described above a language selection function may be accessed using an active area of the first level subject screen 30. In other examples a language selection function may be accessed by an active area any one, some, or all of the different screens displayable by the system 1.

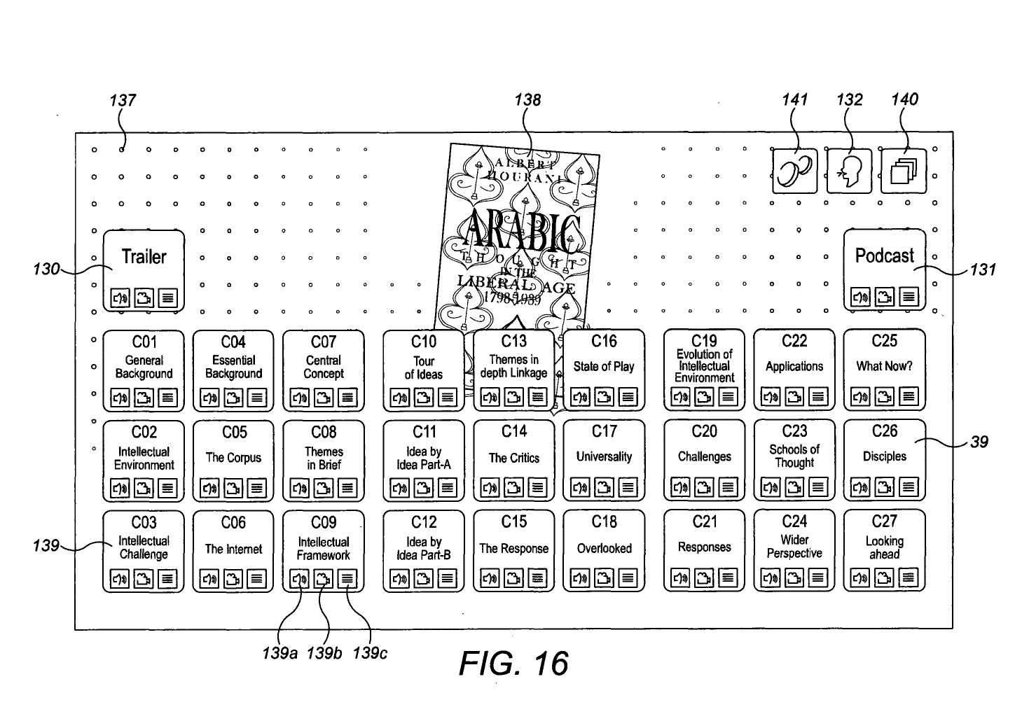

An alternative second embodiment will now be described with reference to FIG. 16.

In the alternative second embodiment an alternative third level analysis and access screen 137 is provided in place of the third level analysis screen 37 according to the first embodiment. In the second embodiment the fourth level lexicon screen 44 of the first embodiment is not used. The third level analysis screen 37 and the fourth level lexicon screen of the first embodiment are both replaced by the third level analysis and access screen 137 in the second embodiment. However, the higher level screens, that is the first level subject screen 30 and the second level book screen 32, are used in the same way in the first and second embodiments.

In the second embodiment a third level analysis screen 137 is rendered in response to a touch on an active book selection area 33 of the second level book screen 32. There are a plurality of third level analysis screens 137, each third level analysis screen 137 being rendered in response to a user touch on an active book selection area 33 of the second level book screen 32 corresponding to a different book 10. As in the first embodiment which third level screen 137 is rendered depends upon the identity of the corresponding book 10 at the time of a user touch, and not directly on which active book selection area 33 is touched.

The third level analysis screen 137 corresponding to a particular, or specific, book 10 includes an active return area 138. The assembly system 1 will respond to a user touch on the active return area 138 by returning to the second level book screen 32 with which the specific third level analysis screen 137 is linked, that is the second level book screen 32 from which the third level analysis screen 137 can be reached through an active book selection area. In the illustrated example the active return area 138 is identified with a thumbnail image of the cover of the particular book 10. In addition to identifying the active return area 138, this thumbnail may provide a user reminder of the particular book to which the third level analysis screen 137 relates.

Each third level analysis screen 137 corresponding to a particular book 10 comprises a plurality of active analysis selection areas 139 each corresponding to a different one of the analyses 12 in the third, analysis level 11 of the structured store 6, which are linked to the particular book 10. The assembly system 1 responds to a user touch on one of the active analysis selection areas 139 by rendering a different content display screen, as will be discussed below.

In the illustrated example there are twenty seven active analysis selection areas 139 each corresponding to a respective one of the set of twenty seven analyses 12 shown in FIGS. 2 and 4a to 4c. Each of the active analysis selection areas 139 is marked with the title of the corresponding analysis to guide user selection. The active analysis selection areas 139 are rendered and displayed grouped together in the sets and modules 15 discussed above regarding the structured store 6. In general, the grouping of the analyses 12 into modules 15 and sets is not of any significance regarding the data structures and links within the structured store 6, but is helpful to guide and assist a user in locating and assembling the desired course materials.

The third level analysis screen 137 also includes an active links control area 140 marked with a linking symbol. The assembly system 1 responds to a touch on the active links control area 140 by displaying a “tunneling view” of the selected book and related books. This tunneling view is described in more detail with reference to FIG. 17.

The third level analysis screen 137 also includes a book purchase control area 141 marked with an icon. The system responds to a touch on the book purchase control area 141 by opening a screen explaining how a user can buy a copy of the book. In some examples this may open a link or screen of a suitable book vendor website.

The third level analysis screen 137 also includes an active trailer control area 130. The assembly system 1 responds to a touch on the active trailer control area 130 by displaying a trailer providing an introduction to the book.

The third level analysis screen 137 also includes an active podcast control area 131. The assembly system 1 responds to a touch on the active podcast control area 131 by providing access to streaming or downloadable media providing a summary or discussion of the book.

The third level analysis screen 137 also includes an active language selection area 132. The assembly system 1 responds to a touch on the active language selection area 132 by providing access to a language selection screen or screens allowing a user to select the language in which information is presented by the system 1.

The third level analysis screen 137 may also include an active glossary control area marked with an icon, which operates in a similar manner to that described regarding the first embodiment.

The third level analysis screen 137 may also include a link to a scrolling linked item display area, which operates in a similar manner to that described regarding the first embodiment.

Each of the active analysis selection areas 139 comprises three smaller media selection sub-areas 139a, 139b and 139c. Each media selection sub-area 139a to 139c corresponds to a different media for providing the data, in the illustrated example the first media selection sub-area 139a corresponds to audio, the second media selection sub-area 139b corresponds to video, and the third media selection sub-area 139c corresponds to text. The assembly system 1 responds to a user touch on one of the media selection sub-areas 139a to 139c by rendering a full screen display content screen providing the analysis corresponding to the selected analysis selection area 139 using the selected media corresponding to the selected media selection sub-area 139a to 139c.

When the use of video or text media is selected, in the full screen display mode all, or substantially all, of the display area of the screen is used to display the selected content. When the use of audio media is selected the screen may display titles or similar information identifying the audio content being presented. The full screen display may include suitable control areas to allow access to the selected content to be controlled by the user, and to allow a user to leave the full screen display mode and return to the third level analysis screen 137. Further, the full screen display may respond to user gesture type touch movements on the display screen.

In the illustrated example media selection sub-areas 139a to 139c are shown for all of the active analysis selection areas 139. In some examples it may not be the case that all analyses of all books are available in all three media types. In such cases the media selection sub-areas 139a to 139c corresponding to media that are not available may be disabled, or not displayed.

In the illustrated example of the second embodiment the structured store 6 does not include the fourth, or lexicon, level 13. Instead, in the illustrated example the third, analysis, level 11 is the lowest level of the structured store 6. In the illustrated example the analyses

In some examples a different number of different media types may be supported and a corresponding different number of media selection sub-areas provided. In some examples the media selection sub-areas may be omitted and each analysis may be provided in one media form only.

In some examples the language selection function provides access to a menu of languages supported by the system 1 and allows a user to select which language they use to access the system. In such examples the information relating to the operation of the system itself, such as text displayed on the displayed screens, will be displayed in the selected language. Further, at least some of the displayable data items will be displayed in the selected language. In some examples, some data items may not be displayed in the selected language. This may be necessary where translations of some data items into the selected language are not available. In some examples some data items may be displayed in both the selected language and another language, typically, this other language will be the original language of a data item or a part of a data item. This may be preferred where it is desirable for a user to have access to the original form of a data item, for example a historically important speech.

An optional display screen 200 is shown in FIG. 17. The display screen 200 shows a view of a currently selected book 201 and a number of other books 202 in a “tunneling view” having the appearance of a perspective view of thumbnail views of the front covers of the different books and of the analyses relating to the different books in an false perspective view having the appearance of a three-dimensional stack of books and analyses. This tunneling view allows the relationships between the different analyses relating to the different books to be readily understood in an intuitive manner.

In some examples the other books 202 shown in the tunneling view may be selected and may be ordered by a user as an aid to visualization of relationships between different analyses. This may assist some users in assembling course materials.

In other examples the other books 202 shown in the tunneling view may be automatically selected by the system 1. This automatic selection may select books 202 containing data items linked to data items in the currently selected book 201. In such examples the displayed screen 200 represents the connections between the different books in a form giving the impression of a tunneling view through the related.

In some examples the displayed books may be selected and ranked in order so that books determined to have the largest degree of connection with a currently selected book 201 appear to be located closer to the currently selected book in the stack. In practice it will only be possible to legibly display a finite number of books. Accordingly, the books selected to be displayed may be those having the largest degree of connection with a currently selected book 201. The degree of connection between books may be assessed in any suitable manner. In some examples the degree of connection may be determined based on the number of links between the data items in the respective books and weights assigned to these links.

The optional display screen 200 may be arranged to be accessed from any desired screen by the use of suitable selection areas on the different screens.

This display may assist a user in visualizing the relationships between different data items and in assembling a course.

To ensure consistency across the very large number of analyses 12, and in some examples, lexicons 14 contained in the structured store 6, the text of each analysis 12 and lexicon 14 may be a dedicated text generated specifically for use in the assembly system 1, and based upon an analysis of the corresponding book 10, taking into account the theme of the corresponding analysis 12 by following a set script or set of instructions.

In one example, the set of instructions for generating each summary lexicon 14a may be to produce a synopsis of the theme of the corresponding analysis 12 in the corresponding book 10. The set of instructions for generating each facts lexicon 14b may be to produce bullet points regarding the theme of the corresponding analysis 12 in the corresponding book 10. The set of instructions for generating each criticism lexicon 14c may be to produce an essay about criticism regarding the theme of the corresponding analysis 12 in the corresponding book 10. The set of instructions for generating each interpretations lexicon 14d may be to produce paragraphs about interpretations regarding the theme of the corresponding analysis 12 in the corresponding book 10. The instructions may define any necessary parameters for generating each lexicon, for example the length of the lexicon.

The analyses 12 and, when present, their constituent lexicons 14, are related to the corresponding book 10 but do not comprise sections of the text of the book 10, although it is possible that the analyses 12 and lexicons 14 may include quotations taken from the corresponding book 10.

The analyses 12 and/or lexicons 14 are stored in the structured store 6 in association with tags relating to the contents of the individual analyses 12 and/or lexicons 14. The tags associated with a particular analysis 12 or lexicon 14 may, for example, identify themes and/or keywords found in that analysis 12 or lexicon 14.

In the illustrated example the visual display 2 is a touch screen display and the interface input module 21 is connected to the visual display 2. In other examples other input means may be provided, for example a mouse and/or keyboard, cooperating with the graphical user interface in a usual manner.

The central processor 3 of the assembly system 1 further comprises a content management module 22. The content management module 22 is adapted to search the tags associated with the analyses 12 and/or lexicons 14 based upon user instructions issued by interaction with the rendered GUI and received through the interface input module 21, and to output the results of the searches to the user on the rendered GUI through the interface output module 20.

The searching of the tags associated with the analyses 12 and/or lexicons 14 may be limited by the user in order to direct it to more useful material. For example the search may be limited to a particular subject or book. Further, since each book is associated with the same analyses arranged in the same sets and modules, the corresponding analyses, sets or modules associated with different books can be regarded as analyses, sets or modules of a particular type and searching can be limited to a particular type of set, module or analysis.

The GUI comprising a plurality of connected screens described above may be used as a browser to allow users to navigate and access the stored data items in the structured store 6.

In addition to the directed navigation discussed above, in some examples the system may allow a user to jump directly to a selected data item, or higher level part of the stored data, such as a specific book. Such a jump destination may be selected as a result of a search, or may be at the discretion of the user.

In the illustrated examples the GUI is further adapted to act as a course builder enabling a user, through the rendered screens of the GUI 5, to select data items, such as individual analyses 12 or lexicons 14 and assemble the selected data items into a set of course materials for a study course. In the illustrated example this additional functionality is provided by the content management module 22.

In order to do this the rendered screens of the GUI can have an additional course builder display element allowing selected data items to be displayed and arranged to form a course of study.

In other examples the course builder display element allowing selected data items to be displayed and arranged to form a course of study may be provided as a separate application or program from the application providing the browser and search functions used to find the data items. It will be understood that both applications may be running simultaneously n order to allow a user to find the necessary course materials and assemble them into a course of study.

In some examples the capability to jump to selected data items rather than following the directed navigation through the stored data may be disabled when the system is operating as a course builder.

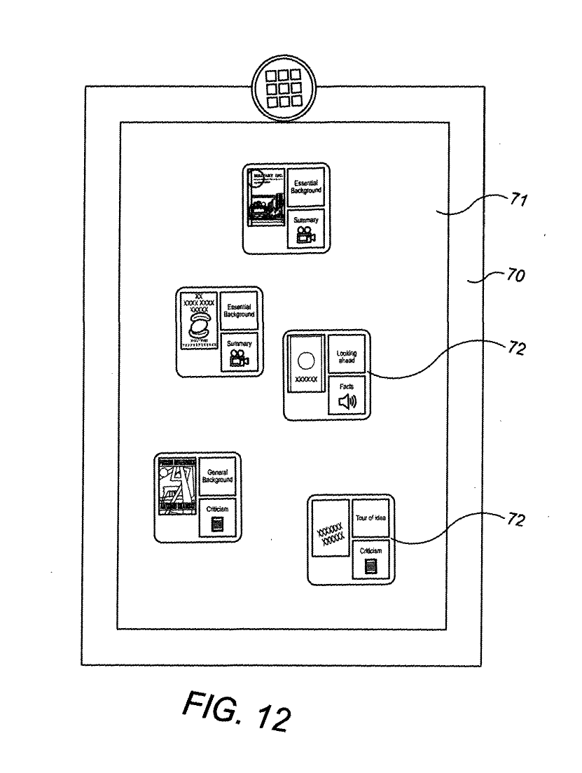

A first example of a course builder display 70 of a graphical user interface according to the present application is shown in FIG. 12. This course builder display 70 can be selectively rendered as a part of the GUI as if it is overlaid on a part of a current rendered GUI, in order to allow the data items shown in the larger rendered GUI to be selected and moved into the course builder 70. The display of the course builder 70 can be selectively enabled or disabled as desired by the user.

The illustrated course builder display can be used together with the browser graphical user interface screens according to either of the first or second embodiments of the invention.

The course builder display 70 comprises a course builder area 71 containing icons 72 representing the selected data items which have already been assembled to form the course materials. In the illustrated example this may be done by dragging and dropping the icon representing an individual data item from another part of the rendered GUI screen into the course builder area 71. In other examples other selection methods may be used.

The selected data items may, for example, be analyses 12 or lexicons 14, as appropriate in different embodiments of the system 1.

The user can move the data items icons 72 around within the course builder area 71 using the GUI.

Further, the user can organize connections between the data items, and these connections 73 will be displayed in the course builder area 71, connecting the corresponding data items icons 72 into a desired relationship to guide study.

In some examples the connections may be established by dragging and dropping the data item icons 72 on top of one another to establish a connection between them. In some examples the connections may be established by drawing a connection line between them, for example by a moving touch on a touch display screen. These examples are not exhaustive, and other methods may be used.

The user can also add annotations relating to the data items, and these annotations 74 are displayed in the course builder area 71 adjacent the corresponding data item icon 72. The user can also add annotations relating to the connections between the data items, and these annotations 75 are displayed in the course builder area 71 adjacent the corresponding connection 73. In some examples, the user can drag annotations around and connect annotations to other elements in addition to the data items and connections. For example, annotations may be added to the data items or to other annotations.

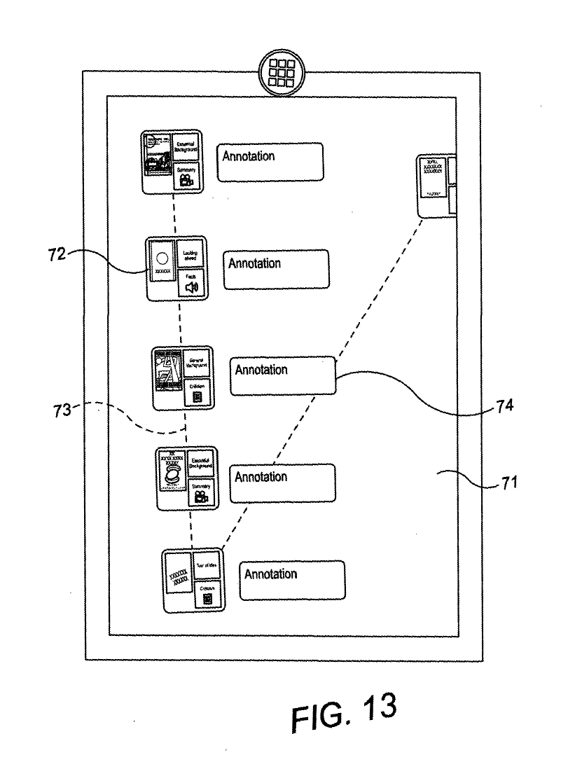

An example of a course arranged as a simple linear sequence of data items is shown in FIG. 13. In this example the data item icons 72, with their related annotations 74 are arranged in a linear sequence connected by connections 73.

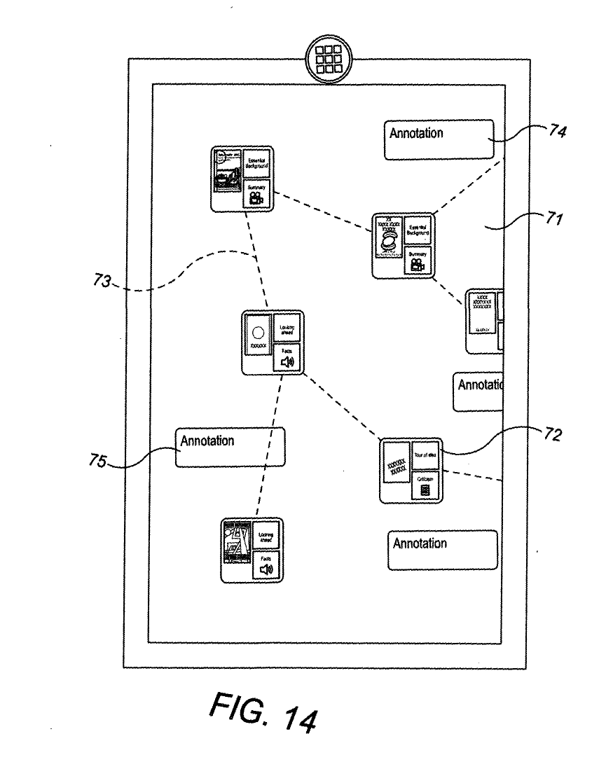

An example of a more topographically complex course structure is shown in FIG. 14. In this example the data item icons 72, with their related annotations 74 are arranged in a network connected by connections 73.

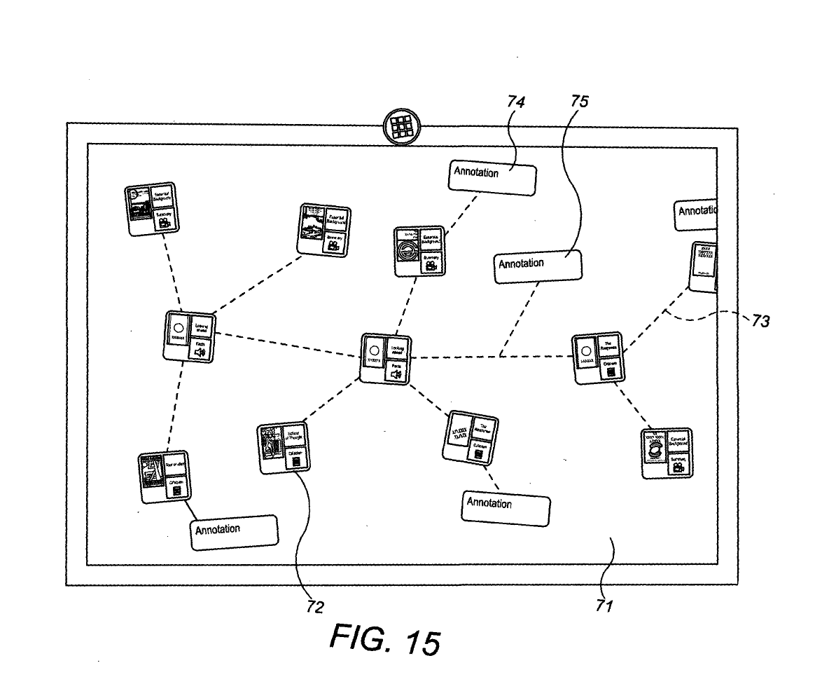

FIG. 15 shows a larger and more complex course of study.

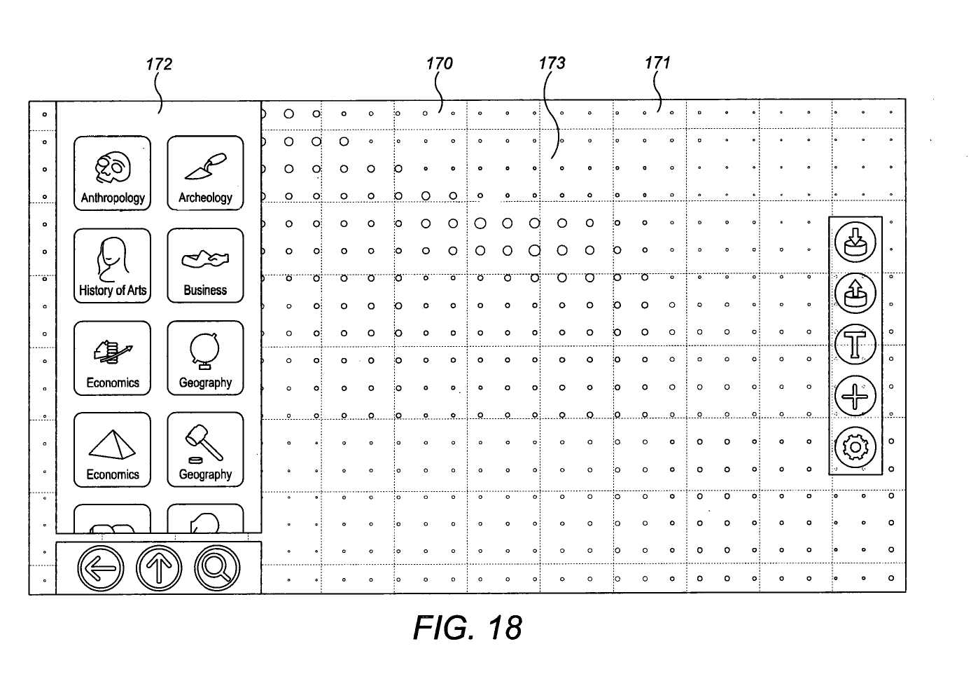

A second example of a course builder display 170 of a graphical user interface according to the present application is shown in FIG. 18. This course builder display 170 can be selectively rendered as a part of the GUI as if it is overlaid on a part of a current rendered GUI, in order to allow the data items shown in the larger rendered GUI to be selected and moved into the course builder 170. Alternatively, the course builder display 170 may be rendered alone. The rendering of the course builder display 170 can be selectively enabled or disabled as desired by the user.

The illustrated course builder display 170 can be used together with the browser graphical user interface screens according to either of the first or second embodiments of the invention.

The course builder display 170 can follow the structure of the structured data store 6 to allow users to easily navigate through the data items stored in the data store 6.

FIG. 18 shows a building screen 171 of the course builder 170. The building screen 171 comprises a selection panel area 172 which can display versions of the screens of the viewer or browser function described above to allow a user to navigate around the structured data store 6 and select data items, and a working area 173 displaying selected components of a course of study for assembly and manipulation by the user.

In FIG. 18 the selection pane area 172 shows a version of the first level subject screen 30.

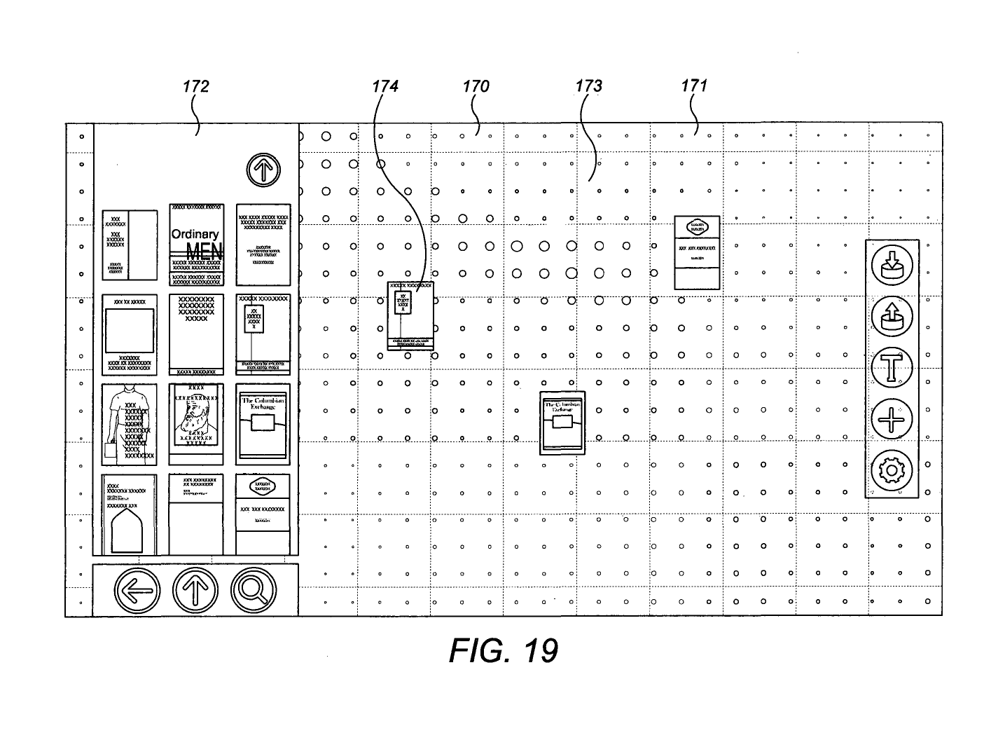

FIG. 19 shows another view of the building screen 171 of the course builder 170. In FIG. 19 the selection pane area 172 shows a version of the second level book screen 32. In FIG. 19 a number of books have been selected to be part of a course of study. Book icons 174 representing the selected books are displayed in the working area 173 of the building screen 171. The book icons 174 represent the selected books using thumbnails of the respective book covers in a manner consistent with the thumbnails used in the book screen 32 to improve user clarity and make the system as intuitive as possible.

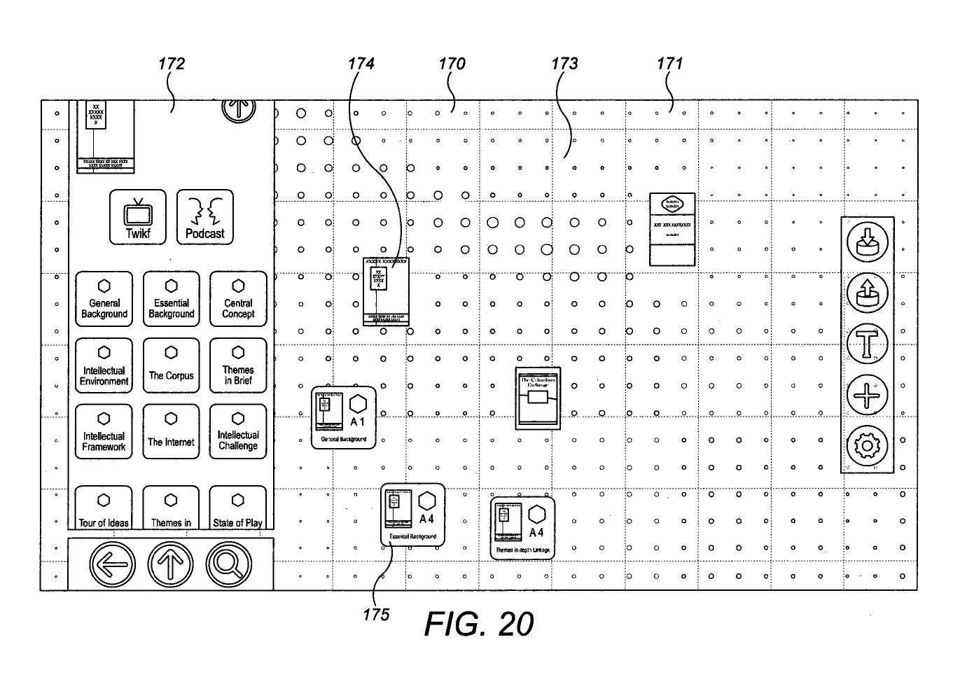

FIG. 20 shows another view of the building screen 171 of the course builder 170. In FIG. 20 the selection pane area 172 shows a version of the third level analysis screen 137 according to the second embodiment displaying available analyses, and also an active return area identified with a thumbnail image of the particular book to which the analyses relate. In FIG. 20 a number of analyses relating to a specific book have been selected to be part of the course of study. Analysis icons 175 representing the selected analyses, in addition to the book icons 174 representing the selected books are displayed in the working area 173 of the building screen 171. The analysis icons 175 represent the selected analyses using the same icons as in the analysis book screen 137 to improve user clarity and make the system as intuitive as possible.

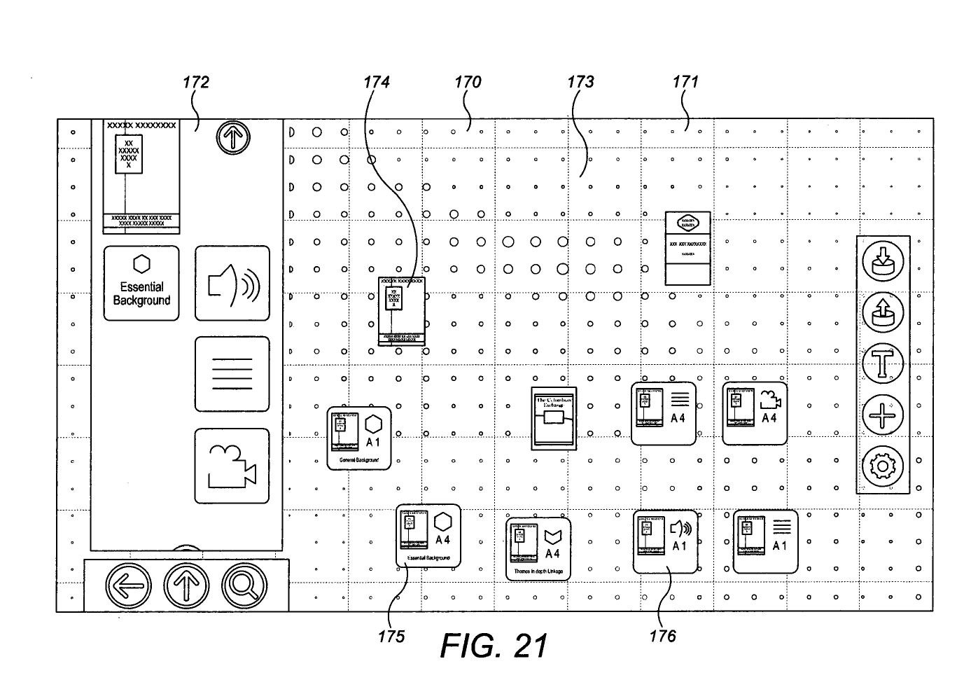

FIG. 21 shows another view of the building screen 171 of the course builder 170. In FIG. 21 the selection pane area 172 shows a version of a single active analysis selection area 139 of the third level analysis screen 137 according to the second, and also active return areas identified with the icon of the analysis which the displayed analysis selection area relates to, and a thumbnail image of the particular book to which the analysis relates. In FIG. 21 a number of analyses using specific media relating to a specific book have been selected to be part of the course of study. Icons 176 representing the selected analyses in the selected media, in addition to the analysis icons 175 and book icons 174, are displayed in the working area 173 of the building screen 171. The icons 176 represent the selected media, the selected analysis, and the selected book, to which they correspond, to improve user.

In a similar manner to the previous example, the user can move the different icons 174 to 176 around within working area 173 of the building screen 171 using the GUI. Further, the user can organize connections 177 between the different icons, and these connections 177 will be displayed in the working area 173 of the building screen 171, connecting the corresponding icons 174 to 176 into a desired relationship to guide study.

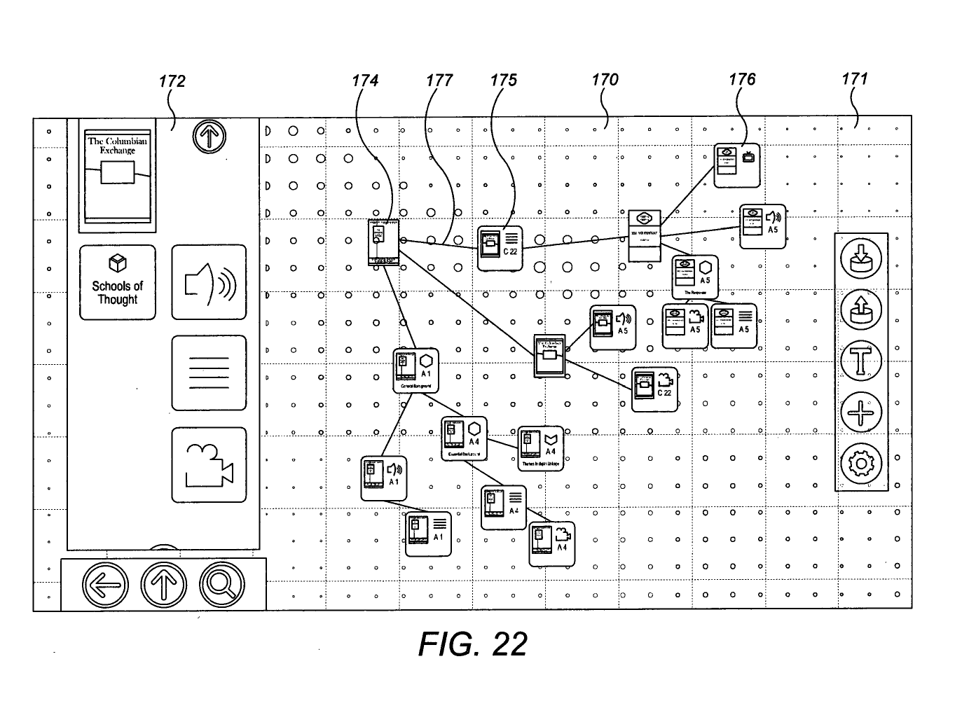

FIG. 22 shows another view of the building screen 171 of the course builder 170 with connections 177 added.

It should be noted that the book icons 174, analysis icons 175 and the icons 176 can all be manipulated and linked in the building screen 171, although only the icons 176 relate to data items.

The zoom level of the building screen 171 can be varied as desired by the user in order to allow the assembled course materials to be seen and manipulated. For example, in the figures the building screen 171 is shown at different zoom levels in FIGS. 21 and 22. In some examples the zoom level of the building screen 171 may be varied automatically to ensure that all of the selected course materials are visible,

In a similar manner to the previous example, the user can add annotations 178 relating to the data items and other icons 174 to 176, and to the connections 177, and these annotations 178 are displayed in the course builder area 71 adjacent the corresponding icon of the course element they are related to. Similarly to the previous example, in some examples the user can drag annotations around, and connect annotations to other annotations.

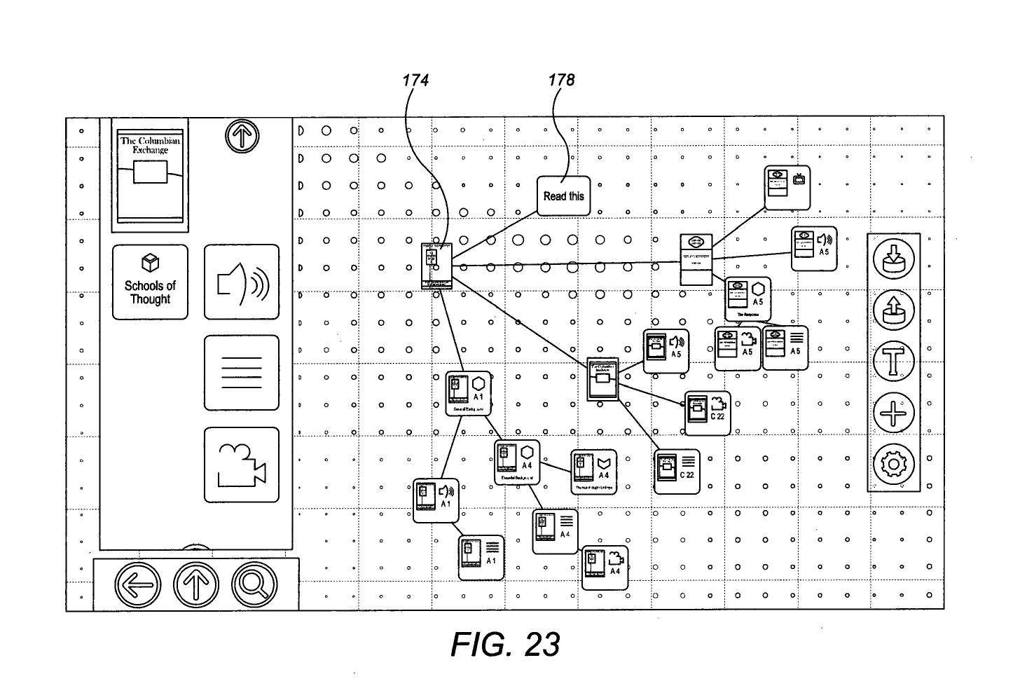

FIG. 23 shows another view of the building screen 171 of the course builder 170. In FIG. 23 an annotation 178 is shown attached to a book icon 174.

The course builder 170 may also be applied to the first embodiment of the invention.

The course of study assembled using the system may be non-linear, and in general may be accessed by users in any order. This allows a student to explore a course in their own manner, choosing their own path through the course content. Of course, in practice it may be desirable or essential that some content items are considered in a particular order, and this may be conveniently be indicated in the annotations. Thus, a course user such as a student may be guided by the course creator but is free to take their own course through the content.

The course of study may be larger in extent than the display area of the course builder area, in this case the course builder area may pan or scroll over the displayed course of study to allow all parts of the course of study to be seen and manipulated.

In some examples the size of the course builder area may be fixed.

In other examples the size of the course builder area may be varied as desired by the user. The user may for example find it convenient to keep the course builder area relatively small while searching for course materials so that the searching and selection screens are not obscured, and then to enlarge the course builder area to allow the selected lexicons to be easily manipulated and organized. The scale at which the course of study is displayed may be varied to allow a user to zoom in and out on different parts of the course of study. This may be useful to allow users to clearly visualize and comprehend large and complex courses.

Some annotations may be intended to be retained in the completed course of study to assist later students following the study course, for example to provide guidance or advice. Some annotations may be intended to be removed from the completed course of study before it is used, such annotations may be used as a memory aid when a course is being assembled, or in a collaborative setting they may be used to guide other members of the course assembly team.

When the assembling by the user using the content management module 22 has produced an assembly of data items which the user regards as suitable to form the basis of a study course the assembly of lexicons can be output as an educational material assembly. In examples where the user is an academic intending to teach a subject to one or more students this output can conveniently be transmitted to a course materials library allowing the students to identify and access the course materials without giving them access to the assembly system 1 itself.

In some examples the stored course of study may be exported to other devices, for example mobile devices, to allow persons to follow the course of study in a convenient manner. In some examples where the stored course of study may be exported to other devices this may be in an editable form allowing the rearrangement or addition of further study materials after the export. In some examples where the stored course of study may be exported to other devices the export may be in a non-editable format for self-study, publication and distribution. In some examples the stored course of study may be printed out as a hardcopy. When the stored course of study is exported any suitable format may in principle be used. The system is not limited to any particular export format or formats. The person skilled in the art will be aware that very many such formats exist.

In some examples the system 1 may also be used in a viewer mode by users wishing to follow a course of study, such as students, to allow the users to view and follow a stored course of study and access that data items forming part of the stored course of study.

In some examples the system operating in viewer mode will not be able to edit or change the stored course of study. In other examples the system operating in viewer mode may be able to save an editable, or partially editable, personal copy of the course of study for the user so that the user can add any comments or annotations they find helpful for their own studies without affecting the master copy of the stored course of study, which may potentially be used and shared by a large number of users.

Use of the system 1 in viewer mode by users following a course of study may be convenient to allow the users to explore topics of interest more deeply starting from the saved course and using the resources of the structured store 6, guided by the hierarchical data structure and saved links.

In some examples the system 1 may be used to teach users, such as academics, how to design a curriculum and/or assemble a course of study. This may be intended to teach the user how to use the system 1, and/or may be intended to teach the user how to design a curriculum. In such examples the assembled course of study may be reviewed and feedback provided to the user to identify any deficiencies in, or possible improvements to, the assembled course of study. In such examples the assembled course of study may not actually be made available for use as a course of study and may be used only as training aid.

Further, the rendered screens of the GUI 5 enable a user using the content management module 22 to arrange the selected data items into a desired structure and to define the links and connections between the different selected data items, and to store the selected data items together with the desired structure and defined links and connections. In some examples the content management module 22 may enable a user to create and define a path through the selected items in a similar manner to a flow chart. In some examples the content management module 22 may enable a user to add text to the stored data items together with the desired structure and defined links and connections to form a syllabus or course of study.

As explained above, in order to identify and select data items a user is able to navigate through the very large number of lexicons 14 stored in the structured store using the hierarchical structure of rendered screens of the GUI 5. The correspondence between the hierarchical structure of the rendered screens of the GUI 5 and the structure of the data structure of the data store 6 allows a user to navigate efficiently and intuitively through the data in the data store 6.

The data items stored in the structured store 6 are linked together in the structure of the structured store 6 whereby, in the illustrated embodiment, each of the lexicons 14 will be linked to a single corresponding analysis 12 and to a single corresponding book 10.

The data items stored in the structured store 6 may also be linked in other ways so that the links indicate and define the connections between the different data items, in addition to the links corresponding to the structure of the structured data store. These links between different data items are the links displayed in the linked item display areas 42 and 50 of the third level analysis screen 37 and the fourth level lexicon screen 44 of the GUI 5. In a preferred example any stored data item may be linked to any other stored data item.

In some examples the structured store 6 may be a relational database which both preserves the hierarchical structure of the stored data items and also stores links between different data items in addition to the hierarchical structure. It will be understood that the hierarchical structure may itself be regarded as defining or being formed by a plurality of links.

Storing these links between different connected data items in the structured data store, identifying the linked data items in the rendered screen of the GUI 5 relating to a particular data item, and providing means to select a linked data item and open a rendered screen relating to the selected linked data item allows a user to easily and efficiently navigate through the data in the data store 6 and identify related data items of interest in assembling a set of course materials.

These links form a web of interconnections between items forming a secondary structure, additional and complimentary to the main hierarchical structure, assisting in understanding and visualizing the relationships between the stored data items.

Accordingly, the present invention may make it possible to assemble a set of course materials and define a syllabus or course of study, or to update an existing course of study, more efficiently, reducing the financial and staff time cost. This may allow more courses to be made available, and/or allow courses to be updated at shorter intervals.

Links may be added by human editors, or similar analysts, based upon connections identified in the books themselves, for example in footnotes or other citations or references. These links may be regarded as primary, or direct, links because they are directly derived from the books themselves.

Further, links may be added by human editors, or similar analysts, based on their understanding of the contents of the book text. Although these links are not directly derived from the text of the books themselves, but from an analysis of the contents of the book, these links may be regarded as primary links because they are based on a human understanding and analysis of the book content.

Further, human editors, or similar analysts, may add tags or keywords to the data items based on the contents of the data items. The content management module 22 is adapted to search through these tags and keywords and generate links between the data items based on the tags and keywords. These links may be regarded as secondary links because they are generated automatically.

In some examples the content management module 22, may be adapted to analyze the contents of the data items, for example the text of the lexicons 14, and tag the data items based on the identified wording. This could, for example, be based on identifying and tagging lexicons containing specific words on a predefined list. These links may be regarded as secondary links. This technique may allow the wholly automated generation of links, which may reduce costs. However, the results of such automated tagging may not be entirely predictable, so it may be preferred not to do this in some implementations.

Where links between different data items are displayed, for example the linked data items displayed in the linked item display areas 42 and 50 of the third level analysis screen 37 and the fourth level lexicon screen 44 of the GUI 5, the displayed linked items may be displayed in a sorted list. In some examples the displayed linked data items may be sorted based on their assessed relevance to show the most relevant linked data items first. In some examples the displayed linked data items may be sorted with a weighting based on the origin of the links. In some examples the displayed linked data items may be sorted based on both their assessed relevance and weighting based on link origin.

The relevance of links may be assessed by human editors, or similar analysts, comparing the linked data items and assigning the link a perceived relevance value. Further, the relevance of links may be assessed automatically, for example by an expert system comparing the linked data items.

In some examples the primary links may be assigned a greater weighting value, and so be displayed preferentially, compared to secondary links. In some examples, secondary links added by human editors, or similar analysts, may be assigned a greater weighting value, and so be displayed preferentially, compared to secondary links generated automatically by the content management module 22 based on human added tags and keywords. In some examples, secondary links generated automatically by the content management module 22 based on human added tags and keywords, may be assigned a greater weighting value, and so be displayed preferentially, compared to secondary links generated entirely automatically by the content management module 22 analyzing the contents of the data items.

In the illustrated example the linked item display area 42 of the third level analysis screen 37 displays a plurality of books linked to the particular book 10 which is the subject of the third level analysis screen 37. As explained above, this displayed plurality of books may be sorted in order to preferentially display more relevant linked books and/or books linked by a link assigned a greater weighting value.

The linked item display area 42 of the third level analysis screen 37 may also display other types of data item which are linked to the particular book 10 which is the subject of the third level analysis screen 37. In examples where other types of data item are linked, the assembly system 1 responds to a user touch on an active linked item selection area by displaying a different screen corresponding to the linked data item identified with the touched active linked item selection area.

In the illustrated example the linked item display area 50 of the fourth level lexicon screen 44 displays a plurality of analyses linked to the particular analysis 12 which is the subject of the fourth level lexicon screen 44. As explained above, this displayed plurality of analyses may be sorted in order to preferentially display more relevant linked analyses and/or analyses linked by a link assigned a greater weighting value.

The linked item display area 50 of the fourth level lexicon screen 44 may also display other types of data item which are linked to the particular analysis 12 which is the subject of the fourth level lexicon screen 44. In examples where other types of data item are linked, the assembly system 1 responds to a user touch on an active linked item selection area by displaying a different screen corresponding to the linked data item identified with the touched active linked item selection area.

The inclusion of links between different types of data item, that is data items on different levels of the hierarchical data structure, may increase the effectiveness of the assembly system by allowing more links between different data items to be included in the structured data store and seen and followed by users. However, the inclusion of links between different types of data item may potentially make the lists of linked data items and the operation of the assembly system more confusing for users. Accordingly, in some examples links between different types of data item may not be included, or may be limited in number.

In some examples the linked item display areas 42 and 50 may display together with the identities of the link data items indications whether the links to these data items are primary or secondary links, and/or whether the links to these data items have been generated based on human input or automatically. In some examples, other information about the links may also be displayed.

In addition to the functionality described above, in some examples the content management module 22 may also provide further search options for selection by the user. By using these search options to search for data items the user may be able to identify data items for inclusion in course materials even when no link to those data items from a current data item is recorded in the database. In some examples these search options may relate to searching the content of the data items. In some examples these search options may include limiting the search to specific authors or groups of authors, specific books or groups of books, books produced in specific time periods or locations and the like. In order to support these options the books 10, and other data items, may be stored in association with searchable tags. In such examples the content management module 22 may be adapted to search the lexicons 14 based upon the associated tags within or across specific subjects or groups of subjects as instructed by user commands. Further, the content management module 22 may be adapted to search the lexicons 14 based upon the associated tags for one, some or all analyses 12 as instructed by user commands.

In addition to the functionality described above, in some examples the content management module 22 may be further adapted to enable a user to add new links between different data items. For example, a user may wish to add a link between two different lexicons 14 having related content which have been identified by searching based upon their associated searchable tags. Such user added links will be added to the database 4. In examples allowing users to add new links where a remote central database is used, the system may be adapted to allow user added links stored in the local database 4 to be sent to and stored in the remote central database.

In addition to the functionality described above, in some examples the content management module 22 may be further adapted to enable a user to add comments and annotations to the data items in order to improve the quality and usefulness of the data items. In such examples a remote central database is used, the system may be adapted to allow user comments and annotations stored in the local database 4 to be sent to and stored in the remote central database.

In some examples search programs other than those incorporated in the content management module 22 may be used to search the stored data items. Such other search programs may be used to search the data items stored in the structured data store, and may be used to add links between different data items. Such other search programs may be proprietary and/or third party software. This may allow better, more useful, links to be generated between the data items by using more powerful or specialist searching tools than those incorporated in the content management module 22. This may allow more powerful or specialist searching tools to be used to search the stored data items, and possibly to generate links, without the system 1 having to make the necessary resources to support these searching tools permanently available.

In some examples the system 1 may be arranged to allow searching of the stored data items by external search programs.

In some examples the system 1 may be arranged to enable a user to add links to third party content in addition to the data items stored in the structured data store. Such third party content may be in remote databases which are not part of the system 1. Further, in some examples the system 1 may be arranged to access and search third party content such as remote databases in addition to the data items stored in the structured data store. The searching of and linking to third party content such as remote databases may allow external databases, such as university databases, to be used if gaps or deficiencies are found in the data items stored in the structured data store. This may be useful to allow highly specialized courses to be produced, or to allow courses to include the very latest research without having to wait for this latest research to be integrated into the structured data store.

The above description refers to storing books 10. In order for the system to function it is only necessary for book identities and related data, such as the analyses 12, to be stored, it is not essential that the content, such as the text, of the books 10 are stored on the system 1. As is explained above the lexicons 14 are text about the corresponding book 10, not text extracted from the corresponding book 10. However, it may be convenient to store the actual content of some or all of the books 10 on the system in order to ensure that this is readily available to users.

In some examples, the system 1 may store links, or pointers to remote storage locations, identifying where the text of some or all of the books 10 may be accessed, rather than storing the actual text of the books 10. In some examples, the system 1 may store some parts of the text of the books 10 and store links or pointers to other parts of the books 10. For example, the system 1 may store only extracts of the text of a particular book 10, and also store a link or pointer to a remote storage location where the full text of the book 10 can be accessed. The remote storage locations may, for example, be servers accessible through the internet.

In some examples the system 1 may be linked to a learner management system, or may output the set of course materials in a format compatible with an external learner management system. Interacting with such a learner management system may assist users, and/or students or learners following the course of study, to track the course and its component materials, such as the component data items assembled into the course of study. Suitable learner management systems are well known, and need not be described in detail herein.

The present invention allows the assembling of educational materials to support a study course to be carried out more efficiently, requiring less user time and input than traditional methods. Accordingly the cost of assembling materials for a new course, or updating or amending the materials used for a course can be reduced, both in financial terms and in terms of the opportunity cost of the staff being unavailable for other tasks. This may allow the range of courses made available or supported by academic or teaching institutions to be increased, and allow more frequent updating of course materials.

The present invention provides an easy to understand, intuitive and clean interface for users to interact with the stored data items.

The illustrated examples relate to an embodiment having a hierarchical data structure with four levels, and a graphical user interface with a corresponding four levels of renderable screens. In other examples the number of levels may be changed. The hierarchical structures of the data structure can in principle be extended to any required number of levels to suitably organize the stored data items, and the organization of the screens of the graphical user interface can be extended in a corresponding manner. The hierarchical structure of the data structure can be extended as necessary by recursive subdivision until the desired level of definition of the data items is achieved.

In some alternative examples there may be an additional level or levels of the hierarchical data structure between the first, or highest, subject level 7 and the second, or next lower, book level 9.

In the illustrated examples the hierarchical data structure is the same across all of the stored data items. In some alternative examples the hierarchical data structure may be different for different stored data items. In one alternative example there may be an additional intermediate level of the hierarchical data structure between the first, or highest, subject level 7 and the second, or next lower, book level 9 for some, but not all, subjects. In such an example the additional intermediate level of the hierarchical data structure may be present for subjects having a larger number of books. This may assist a user in dealing with subjects where a large amount of source material is available without being overwhelmed.

The above description refers to the data items as books and also refers to lexicon texts. In other examples some or all of the data items may instead be text documents in formats other than books. In particular, some or all of the data items may instead be journal articles, academic papers, theses, and the like. In alternative examples some or all of the data items could be presentations of information in non-text formats, for example films, television programs, radio programs, or music recordings. In some examples some or all of the lexicons could include or comprise images, video footage, sound recording, and/or multi-media presentations in addition to or instead of text. These lists are not intended to be limiting or exhaustive.

In some examples the data items and/or lexicons may be available in multiple formats. For example, a data item could be available as text, an audio clip of the text being spoken, and/or a video clip of the text being spoken. In such examples the display screens may include active control areas allowing the format in which the data item is delivered to be selected by a user. Such active control areas may for example be provided in the lexicon screen 44 of FIG. 10 and the screen 137 of FIG. 16.

In the illustrated example the first level subject screen 30 may include active areas allowing access to a help function, a dictionary, a glossary, a language selection function, or the like. In other examples active areas and/or controls allowing access to these functions may be provided in other screens rendered by the system.

The illustrated example uses a touch display and is described as responding to user touches. In some examples other methods of user input and selection may be used, such as mice, trackballs, keyboards and the like. Many such methods of user interaction with a GUI are well known, and need not be described in detail. In some examples the system may be a conventional PC.

In the illustrated example books are identified to a user in the displayed rendered screens of the GUI by displaying a thumbnail representation of the cover of the book. In some examples other methods of identifying the books may be used. In some examples the titles of books may be displayed. In some examples a user may be able to select how books are identified to the user. In some examples where thumbnail representations of covers are used to identify books, some books may instead, or additionally be identified by title. This may be done, for example, when the book cover is insufficiently distinctive.

In some examples an animation may be displayed when moving between screens. Where the movement is from a higher level screen to a lower level screen the animation may show the selected icon or display element on the higher level screen breaking apart, and zoom in the display towards a selected part of the display element. Where the movement is from a lower level screen to a higher level screen the animation may zoom out form a selected display element and show a display element on the higher level screen coming together. Animations of this type may assist users in keeping track of their navigation through the stored data structure.

In some examples the system 1 may provide further functionality to the users in addition to that discussed above. In some examples the system may provide the users with a notebook function to allow notes to be made. In some examples the system may provide the users with a share function allowing different users to compare notes. In some examples the system may provide the users with a progress check function allowing progress through a selected course of study to be assessed and recorded. In some examples the system may provide the users with a test or quiz function to allow questions about the course of study to be posed and answered. In some examples the system may provide the users with a chat function to allow communication between users.

In some examples the system 1 may control access by users to authorized users having accounts with a system operator. This control may be by the use of login names and passwords, or other known access control techniques.

In some examples the assembly system 1 may be able to present information to a user in multiple languages. In such examples the assembly system may be adapted to allow a user to select the language used. Some examples of how this may be done are discussed above.

In some examples the rendered screens and displayable data items are stored and presented as web pages and the system 1 comprises a browser showing the web pages.

The assembly system 1 is provided by a programmable general purpose computer with the different modules and functions being provided by suitable software elements. In other examples some or all of the modules and functions may be provided by dedicated processing hardware.

The embodiments described above relate to a system and method for assembling course materials to support a study course. The system and method can be applied to other applications where it is desired to assemble data items for a particular purpose.

In particular, in one example the system and method may be used to search and assemble materials relating to jobs. In such examples the assembled materials may be used to assist in career development, recruitment and human resources (HR) management. In some such examples the first, or highest level, of the structured store may divide the stored materials into different professions, rather than different subjects.

The apparatus described above may be implemented at least in part in software. Those skilled in the art will appreciate that the apparatus described above may be implemented using general purpose computer equipment or using bespoke equipment.

The hardware elements, operating systems and programming languages of such computers are conventional in nature, and it is presumed that those skilled in the art are adequately familiar therewith. Of course, the server functions may be implemented in a distributed fashion on a number of similar platforms, to distribute the processing load.

Here, aspects of the methods and apparatuses described herein can be executed on a computing device such as a server. Program aspects of the technology can be thought of as “products” or “articles of manufacture” typically in the form of executable code and/or associated data that is carried on or embodied in a type of machine readable medium. “Storage” type media include any or all of the memory of the computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

Hence, a machine readable medium may take many forms, including but not limited to, a tangible storage carrier, a carrier wave medium or physical transaction medium. Non-volatile storage media include, for example, optical or magnetic disks, such as any of the storage devices in computer(s) or the like, such as may be used to implement the encoder, the decoder, etc. shown in the drawings. Volatile storage media include dynamic memory, such as the main memory of a computer platform. Tangible transmission media include coaxial cables; copper wire and fiber optics, including the wires that comprise the bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those skilled in the art will appreciate that while the foregoing has described what are considered to be the best mode and, where appropriate, other modes of performing the invention, the invention should not be limited to specific apparatus configurations or method steps disclosed in this description of the preferred embodiment. It is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. Those skilled in the art will recognize that the invention has a broad range of applications, and that the embodiments may take a wide range of modifications without departing from the inventive concept as defined in the appended claims.

Although the present invention has been described in terms of specific exemplary embodiments, it will be appreciated that various modifications, alterations and/or combinations of features disclosed herein will be apparent to those skilled in the art without departing from the spirit and scope of the invention as set forth in the following claims.

1. An electronic system for providing educational course materials, the system comprising:
a processor connected to a data store, a display device, and a user input means;
the data store containing a plurality of data items arranged in a data structure;
the processor being configured to render a graphical user interface comprising a plurality of separately renderable connected screens on the display device, wherein:
the renderable screens of the graphical user interface comprise active areas selectable using the user input means to navigate between connected ones of the renderable screens;
the renderable screens being connected in a structure corresponding to the data structure of the plurality of data items;
the renderable screens of the graphical user interface comprise active areas selectable using the user input means to enable user selection of data items from the plurality of data items; and
the processor being configured to group the selected data items to form educational course materials.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A method for providing educational course materials using an electronic system comprising a processor connected to a data store containing a plurality of data items arranged in a data structure, a display device, and a user input means, the method comprising:
rendering a graphical user interface comprising a plurality of separately rendered connected screens on the display device, wherein:
the rendered screens of the graphical user interface comprise active areas selectable using the user input means to navigate between connected ones of the rendered screens;
the rendered screens are connected in a structure corresponding to the data structure of the plurality of data items; and
the rendered screens of the graphical user interface comprise active areas selectable using the user input means to enable user selection of data items from the plurality of data items; the method further comprising:
using the user input means to select active areas of the rendered screens of the graphical user interface to navigate between connected ones of the rendered screens;
using the user input means to select active areas of the rendered screens of the graphical user interface to select data items from the plurality of data items; and
grouping the selected data items to form educational course materials.

21. The method according to claim 20, wherein the data structure of the plurality of data items is a hierarchical data structure, and the rendered screens are connected in a hierarchical structure corresponding to the hierarchical data structure.

22. The method according to claim 21, wherein the data structure comprises a plurality of topics, and a plurality of data items relating to each topic.

23. The method according to claim 22, wherein the data items relating to each topic are grouped into a plurality of analyses, the analyses are grouped into a plurality of modules, and the modules are grouped into a plurality of sets, whereby each topic has an associated plurality of sets of modules of analyses of data items.

24. The method according to claim 23, wherein each topic has the same number of sets associated with it, each set comprises the same number of modules, each module comprises the same number of analyses, and each analysis comprises the same number of data items.

25. The method according to claim 23, wherein the analyses relating to different topics are derived from the corresponding topics according to a consistent common arrangement.

26. The method according to claim 24, wherein each topic has three sets associated with it, each set comprises three modules, each module comprises three analyses, and each analysis comprises four data items.

27. The method according to claim 22, wherein the data items within each set relate to a different facet of the topic.

28. The method of claim 27, wherein each topic has first, second and third sets associated with it, and the data items in a first set relate to facts regarding the topic, the data items in the second set relate to interpretation and explanation of the facts, and the data items in the third set relate to critical responses to the facts.

29. The method according to claim 22 wherein the data structure comprises a plurality of subjects, and each subject comprises a plurality of topics.

30. The method according to claim 22 wherein a topic corresponds to a book.

31. The method according to claim 20, wherein the rendered screens comprise a plurality of renderable screens which each correspond to a specific data item.

32. The method according to claim 31, wherein the data store further contains links between different data items in the data structure; and
the rendered screen corresponding to a specific data item comprises an area identifying different data items in the data structure which are linked to the specific data item.

33. The method according to claim 32, wherein the area identifying different data items in the data structure comprises an active area selectable using the user input means to navigate to a rendered screen corresponding to a different data item in the data structure which is linked to the specific data item; and
the method further comprises using the user input means to select the active area of the rendered screen of the graphical user interface to navigate to a rendered screen corresponding to the different data item which is linked to the specific data item.

34. The method according to claim 32, wherein the area identifying different data items in the data structure displays a plurality of different data items.

35. The method according to claim 34, wherein the area identifying different data items in the data structure displays a sorted list of different data items.

36. The method according to claim 35, wherein the data store further contains weighting values associated with the links between different data items in the data structure; and
the sorted list of data items is sorted in order based, at least in part, on the weighting values associated with the links.

37. (canceled)

38. (canceled)

39. An electronic system for providing assemblies of related materials, the system comprising:
a processor connected to a data store, a display device, and a user input means;
the data store containing a plurality of data items arranged in a data structure;
the processor being configured to render a graphical user interface comprising a plurality of separately renderable connected screens on the display device, wherein:
the renderable screens of the graphical user interface comprise active areas selectable using the user input means to navigate between connected ones of the renderable screens;
the renderable screens being connected in a structure corresponding to the data structure of the plurality of data items;
the renderable screens of the graphical user interface comprise active areas selectable using the user input means to enable user selection of data items from the plurality of data items; and
the processor being configured to group the selected data items to form an assembly of related materials.

40. A method for providing assemblies of related materials using an electronic system comprising a processor connected to a data store containing a plurality of data items arranged in a data structure, a display device, and a user input means, the method comprising:
rendering a graphical user interface comprising a plurality of separately rendered connected screens on the display device, wherein:
the rendered screens of the graphical user interface comprise active areas selectable using the user input means to navigate between connected ones of the rendered screens;
the rendered screens are connected in a structure corresponding to the data structure of the plurality of data items; and
the rendered screens of the graphical user interface comprise active areas selectable using the user input means to enable user selection of data items from the plurality of data items; the method further comprising:
using the user input means to select active areas of the rendered screens of the graphical user interface to navigate between connected ones of the rendered screens;
using the user input means to select active areas of the rendered screens of the graphical user interface to select data items from the plurality of data items; and
grouping the selected data items to form an assembly of related materials.

41. A computer program comprising computer readable instructions which, when executed by a processor.
render a graphical user interface comprising a plurality of separately rendered connected screens on the display device, wherein:
the rendered screens of the graphical user interface comprise active areas selectable using the user input means to navigate between connected ones of the rendered screens;
the rendered screens are connected in a structure corresponding to the data structure of the plurality of data items; and
the rendered screens of the graphical user interface comprise active areas selectable using the user input means to enable user selection of data items from the plurality of data items; the computer readable instructions causing the processor to:
use the user input means to select active areas of the rendered screens of the graphical user interface to navigate between connected ones of the rendered screens.
use the user input means to select active area of the rendered screens of the graphical user interface to select data items from the plurality of data items; and
group the selected data items to form an assembly of related materials.

42. (canceled)
